(19) United States
(12) Patent Application Publication
(10) Pub. No.: US 2004/0220831 A1
(43) Pub. Date: Nov. 4, 2004

(54) Method and system for facilitating medical diagnostic coding

(76) Inventor: Christopher J. Fabricant, Red Bank, NJ (US)

Correspondence Address: REED SMITH LLP, 2500 ONE LIBERTY PLACE, 1650 MARKET STREET, PHILADELPHIA, PA, 19103, US

(21) Appl. No.: 10/758,234

(22) Filed: Jan. 15, 2004

Related U.S. Application Data
(60) Provisional application No. 60/440,444, filed on Jan. 16, 2003.

(51) Int. Cl. G06F 17/60; G06F 17/00; G06F 7/00

(52) U.S. Cl. 705/2; 707/104.1

(57) ABSTRACT

A computer program product being embodied on a computer readable medium and for facilitating medical diagnosis coding, the computer program product includes: data corresponding to the Tabular List of ICD9-CM being stored in at least a first table so as to preserve a hierarchy associated with the ICD9-CM; code for receiving user input for navigating through the Tabular List to a desired portion of the data corresponding to the Tabular List; and, code for displaying the desired portion of the data corresponding to the Tabular List with at least one other portion of the data indicative of the Tabular List so as to present the desired portion of the data in the hierarchy.

### RELATED APPLICATION

This application claims priority of copending U.S. Patent Application Serial No. 60/440,444, filed Jan. 16, 2003, entitled METHOD AND SYSTEM FOR FACILITATING MEDICAL DIAGNOSTIC CODING, the entire disclosure of which is hereby incorporated by reference as if being set forth in its entirety herein.

### FIELD OF THE INVENTION

The invention relates to search and coding technologies and computer software, and, more specifically, to computer software for facilitating diagnostic coding, as is performed by health care and other professionals.

### BACKGROUND OF THE INVENTION

The International Classification of Diseases, 9th Revision, Clinical Modification (ICD9-CM) is published annually by the United States Federal Government and serves as a key reference within the health care and related professions. It provides numeric codes for describing the ‘clinical picture’ of any patient. The codes facilitate matters such as reimbursement for health services, evaluation of utilization patterns and epidemiologic research.

Within ICD9-CM, three volumes are identified: (1) Tabular List of Diseases, (2) Alphabetic Index to Diseases and (3) Tabular List and Alphabetic Index to Procedures. The Tabular List of Diseases and the Alphabetic Index to Diseases are used by physicians and hospitals to report patients' conditions. These volumes shall be considered below. The Tabular List and Alphabetic Index to Procedures is used almost exclusively by hospital medical records departments to describe procedures performed on patients. This volume shall not be considered further.

The Tabular List of Diseases (Tabular List) is the definitive resource for diagnostic coding in the United States. It provides a comprehensive classification scheme, wherein diseases are organized into various categories and subcategories and wherein they are accompanied by unique numeric or alphanumeric codes. Furthermore it provides, throughout the classification scheme, instructions for properly matching diseases and codes to clinical circumstances.

The Alphabetic Index to Diseases (Alphabetic Index) is designed to be used in conjunction with the Tabular List. Specifically, it is designed to be consulted first, before the Tabular List, and to provide an appropriate cross-reference. It is comprised of medical terms and, beside them, numeric codes. The medical terms are listed in alphabetic order, and they relate to symptoms, diseases, conditions, etc. The numeric codes point to specific items within the Tabular List.

For anyone looking to determine a diagnostic code for a patient, ICD9-CM offers the following guidelines. First, bring to mind a medical term relating to the condition of the patient. Second, look up the term in the Alphabetic Index. Third, make a cross-reference. That is, move from the term in the Alphabetic Index to a corresponding condition in the Tabular List. Fourth, after reading any instructions that accompany the condition, select an appropriate diagnostic code.

According to these guidelines, the coder should follow a straightforward sequence of steps to determine an appropriate diagnostic code for a particular patient. To follow that sequence requires that the coder perform certain activities including viewing, navigating, searching, cross-referencing, etc. within the Tabular List and Alphabetic Index. It would be an advantage to the coder to be able to perform such activities easily and efficiently. If the coder commonly makes use of certain diagnostic codes, then it may be an advantage to the coder to have a separate subset listing of these codes.

### SUMMARY OF THE INVENTION

A computer program product being embodied on a computer readable medium and for facilitating medical diagnosis coding, the computer program product including: data corresponding to the Tabular List of ICD9-CM being stored in at least a first table so as to preserve the ICD9-CM hierarchy; code for receiving user input for navigating through the Tabular List to a desired portion of the data corresponding to the Tabular List; and, code for displaying the desired portion of the data corresponding to the Tabular List with at least one other portion of the data indicative of the Tabular List so as to present the desired portion of the data in the hierarchy.

### BRIEF DESCRIPTION OF THE DRAWINGS

Understanding of the present invention will be facilitated by consideration of the following detailed description of an embodiment of the present invention, taken in conjunction with the accompanying drawings, wherein like numerals refer to like parts, and wherein:

FIG. 1 is a screen shot of the Tabular List of the invention.

FIG. 2 is another screen shot of the Tabular List of the invention.

FIG. 3 is a screen shot of the Alphabetic Index of the invention.

FIG. 4 is another screen shot of the Alphabetic Index of the invention.

FIG. 5 is another screen shot of the Alphabetic Index of the invention.

FIG. 6 is another screen shot of the Tabular List of the invention.

FIG. 7 is another screen shot of the Tabular List of the invention.

FIG. 8 is a screen shot of the Custom List of the invention.

FIG. 9 is another screen shot of the Custom List of the invention.

FIG. 10 is a screen shot of the Custom List of the invention.

FIG. 11 is another screen shot of the Custom List of the invention.

FIG. 12 is a screen shot of the Custom List of the invention.

FIG. 13 is another screen shot of the Custom List of the invention.

FIG. 14 is another screen shot of the Tabular List of the invention.

FIG. 15 is another screen shot of the Tabular List of the invention.

FIG. 16 is another screen shot of the Custom List of the invention.

FIG. 17 is another screen shot of the Custom List of the invention.

FIGS. 18a and 18b are flow diagrams illustrating a method of generating a Custom List.

FIG. 19 is another screen shot of the Tabular List of the invention.

FIG. 20 is another screen shot of the Tabular List of the invention.

FIG. 21 is another screen shot of the Tabular List of the invention.

FIG. 22 is another screen shot of the Tabular List of the invention.

FIG. 23 is another screen shot of the Tabular List of the invention.

FIG. 24 is another screen shot of the Tabular List of the invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical search, coding, and navigation technology. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention stores standard information relating to diagnostic coding and derived from the Tabular List and Alphabetic Index in a database, from which said information is accessible by digital technologies, and moreover it stores said information in a manner that will allow said information to be harvested and then organized into a hierarchical scheme.

The present invention provides methods (computer software) by which said information may be harvested from said database, organized into a hierarchical scheme, saved in random access memory, and selectively displayed according to user input within a collapsing hierarchical scheme.

The present invention provides methods (computer software) giving maximum flexibility with respect to the manner by which said information is selectively displayed within a collapsing hierarchical scheme.

The present invention provides methods (computer software) allowing for instantaneous changes to the manner with which said information is selectively displayed within a collapsing hierarchical scheme.

The present invention provides methods (computer software) by which said information harvested from said database and selectively displayed within a hierarchical scheme may be easily and efficiently navigated, searched, cross-referenced, and otherwise manipulated by the user.

The present invention provides methods (computer software) by which the user may define a subset or subsets of said information to be harvested from said database, to be saved in random access memory, to be selectively displayed within a collapsing hierarchical scheme, and to be navigated, searched, cross-referenced, and otherwise manipulated.

The present invention provides methods (computer software) by which the user may place user-defined information into a custom list, organized according to a specific hierarchical scheme (i.e. disease category, subcategory, entity and code), and by which said information may be stored in a database, harvested and selectively displayed according to user input within a collapsing hierarchical scheme.

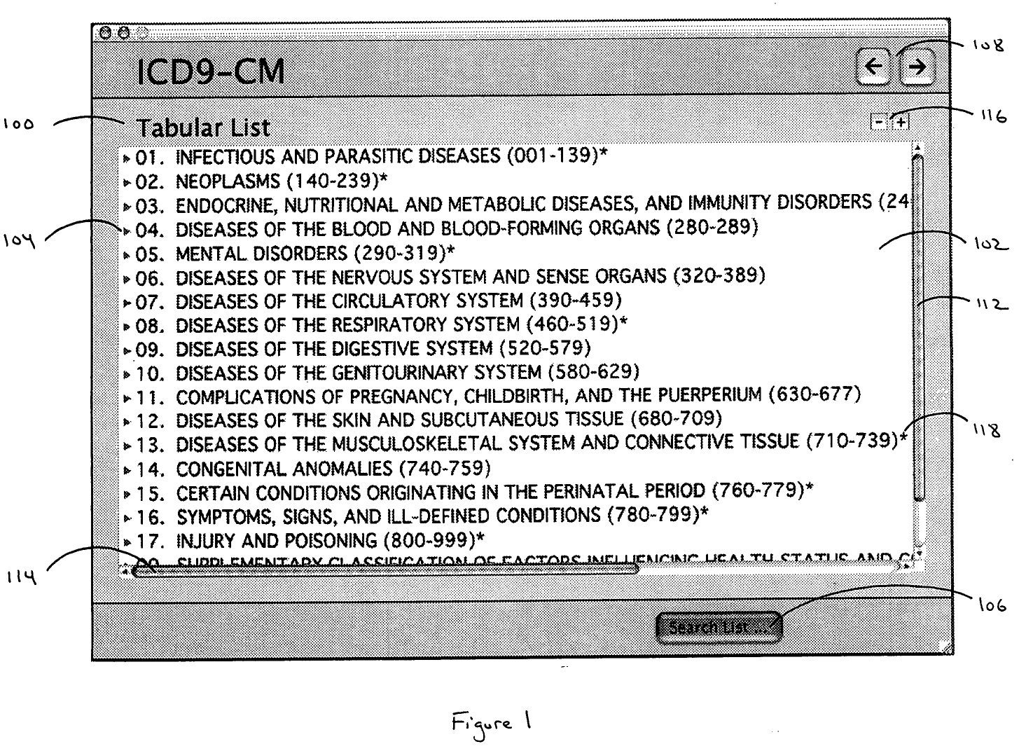

According to an aspect of the present invention, medical diagnosis codes, such as ICD9-CM or ICD-10 codes, may be organized in the shape of a pyramid, with each row of objects linked to objects directly beneath it. According to an aspect of the present invention, the hierarchically organized medical diagnosis codes may be provided for use by a user in a collapsible tree structure in such a way so as to enable a user to view and navigate through the organizational tree without losing the context of the provided information. This represents a significant advancement in the art, as for example the first ten (10) categories illustrated in FIG. 1 (namely Infectious and Parasitic Diseases through Diseases of the Genitournary System) conventionally span hundreds of pages of reference material. Further, and as will be recognized by those possessing an ordinary skill in the pertinent arts, not only is this information provided in such a manner to enable systemic viewing, by providing such a collapsible tree structure, as one navigates down a branch, one maintains the context of such information with respect to other provided information.

According to an aspect of the present invention, data from the Tabular List of Diseases of ICD9-CM (Tabular List) may be organized into a hierarchical scheme. Such data may be organized into data more essential to the scheme (primary data) than other data (secondary data).

More particularly, data from the Tabular List may be organized into 19 specific categories. The first appearing category may be “INFECTIOUS AND PARASITIC DISEASES (001-139);” the second appearing category is “NEOPLASMS (140-239);” and so on. Within a given category, the data may be organized into subcategories and then may be organized into disease entities of increasing specificity. Within the category “INFECTIOUS AND PARASITIC DISEASES (001-139),” the first appearing subcategory may take the form of “INTESTINAL INFECTIOUS DISEASES (001-009),” and within the subcategory “INTESTINAL INFECTIOUS DISEASES (001-009),” the first appearing disease entity may take the form of “001 Cholera,” and within the disease entity “001 Cholera,” the first appearing more specific disease entity is “001.0 Due to Vibrio cholerae.” In this manner, data from the Tabular List may exist in any of five levels, where level 1 is for disease categories, level 2 is for disease subcategories, level 3 is for disease entities, level 4 is for more specific disease entities, and level 5 is for even more specific disease entities. Importantly, the data from one level to the next exhibit strict parent-to-child relationships, which means: that any category (level 1) may be associated with one or many subcategories (level 2) but that any subcategory (level 2) may be associated with one, and only one, category (level 1); that any subcategory (level 2) may be associated with one or many disease entities (level 3) but that any disease entity (level 3) may be associated with one, and only one, subcategory (level 2); that any disease entity (level 3) may be associated with one or many more specific disease entities (level 4) but that any more specific disease entity (level 4) may be associated with one, and only one, disease entity (level 3); and so on.

As described above, data from the Tabular List are organized into a hierarchical scheme. Notably, data that are more essential to that scheme, which hereafter shall be referred to as “primary data,” are commingled with data that are not as essential to it, which hereafter shall be referred to as “secondary data.” As an example of primary data, consider the first appearing category: “INFECTIOUS AND PARASITIC DISEASES (001-139).” As an example of secondary data, consider the instructions that accompany the first appearing category: “Note: Categories for ‘late effects’ of infectious and parasitic diseases are to be found at 137-139.”+chr(13)+chr(13)+“Includes: diseases generally recognized as communicable or transmissible as well as a few diseases of unknown but possibly infectious origin”+chr(13)+chr(13)+“Excludes: acute respiratory infections (460-466)”+chr(13)+“carrier or suspected carrier of infectious organism (V02.0-V02.9)”+chr(13)+“certain localized infections”+chr(13)+“influenza (487.0487.8)”.

In general, primary data exists as relatively short strings, being suited for display in single lines, whereas secondary data may exist as long strings, well suited for display as multiple lines or as paragraphs. According to an aspect of the present invention, primary data may be displayed within a hierarchical listbox, whereas secondary data may be made available for display within a pop up window.

According to an aspect of the present invention, data from the Alphabetic Index to Diseases of ICD9-CM (Alphabetic Index) may be organized into a hierarchical scheme. Among the data, some are more essential to that scheme (primary data) than others (secondary data).

The data from the Alphabetic Index may be organized into 26 specific categories, corresponding to the letters in the alphabet. The first appearing category may be the letter “A,” the second appearing category is the letter “B,” the third appearing category is the letter “C,” and so on. Within a given category, the data may be organized into subcategories, corresponding to words or phrases that begin with that given letter and presented in proper alphabetic order. Hence, within category “C,” the first appearing subcategory is “Cacergasia,” the next appearing subcategory is “Cachexia,” and the next appearing subcategory is “Café au lait spots.” According to an aspect of the present invention, the data of a given subcategory may end with a numeric or alphanumeric code, which points to a particular item within the Tabular List. Hence, within category “C,” the first appearing subcategory may not just be “Cacergasia” but rather be “Cacergasia 300.9,” where 300.9 is a numeric code that points to a particular item in the Tabular List, and the second appearing subcategory is not just “Cachexia” but rather is “Cachexia 799.4,” where 799.4 is a numeric code that points to a particular item within the Tabular List. Within a given subcategory, the data may be further subcategorized. Hence, within the subcategory “Cachexia 799.4,” the first appearing sub-subcategory may be “cancerous (M8000/3) 199.1,” the second appearing sub-subcategory “cardiac—see Disease, heart,” and so on. Within a given sub-subcategory, the data may be further subcategorized; within a given sub-sub-subcategory, the data may be further subcategorized, and so on. In this manner, data from the Alphabetic Index may exist in any of numerous levels.

As described above, data from the Alphabetic Index may be organized into a hierarchical scheme. Notably, data that are more essential to that scheme, which hereafter shall be referred to as “primary data,” are commingled with data that are not as essential to it, which hereafter shall be referred to as “secondary data.” As an example of primary data, consider the following sub-subcategory, which is found within the subcategory “Amputation,” which is found within the category “A:” “traumatic (complete) (partial)” As an example of secondary data, consider the instructions that accompany this sub-subcategory: “Note: ‘Complicated’ includes traumatic amputation with delayed healing, delayed treatment, foreign body, or infection.”

Primary data may exist as relatively short strings, well suited for display in single lines, whereas secondary data may exist as long strings, well suited for display as multiple lines or as paragraphs. According to an aspect of the present invention, primary data may be displayed within a hierarchical listbox, whereas secondary data are made available for display within a pop up window.

According to an aspect of the present invention, data from the Tabular List may be stored in a column String of a table (which table may be referred to herein as ICD9CMVOL1 for sake of explanation only) in a Valentina database The database serves to store both primary and secondary data. Each field within the column String may include primary data and may include secondary data. If a field contains both, then the primary data and the secondary data may be separated by a suitable delimiter, such as the term “###.” Further, if a field contains both, then the primary data may be appended with a marker, such as the character “*.”

According to an aspect of the present invention, data from the Tabular List may be stored in a table ICD9CMVOL1 in a serial fashion, such that the first appearing data from the Tabular List is placed within the first record of the table ICD9CMVOL1, that the next successive appearing data from the Tabular List is placed within the second record, that the next successive appearing data from the Tabular List is placed within the third record, and so on.

According to an aspect of the present invention, not only the data from the Tabular List may be stored in the table ICD9CMVOL1, but other information may also be stored there. For example, information relating to the level, of the five levels, to which the data belongs may be stored. This information may be stored as a numeric character (either 1, 2, 3, 4 or 5). Information serving as a unique identifier and pointing to a specific location, a “home address”, within the hierarchical scheme may also be stored in the table. This information may be stored as a string, wherein suitable characters, such as commas, alternate with numeric characters (e.g., 6,4,5,1). The first numeric character may point to a particular category of level 1, the second (if present) point to a particular subcategory of level 2, the third (if present) point to a particular disease entity of level 3, the fourth (if present) point to a particular more specific disease entity of level 4, and the fifth (if present) point to a particular even more specific disease entity of level 5. Hence the HomeAddress given as, “6,4,5,1” may point to a location at the sixth (6) category, at the fourth (4) subcategory therein, at the fifth (5) disease entity therein, and at the first (1) more specific disease entity therein.

According to an aspect of the present invention, both the primary and secondary data from the Alphabetic Index may be stored in a serial fashion within the column String of a second table (referred to herein as table ICD9CMVOL2 for sake of non-limiting explanation only). This second table may be stored in a Valentina database, or other suitable program. Information relating to the level to which the data belongs may be stored in the second table within a column (that may be designated SortTag by way of non-limiting example only).

According to an aspect of the present invention, data from both the Tabular List and the Alphabetic Index may be displayed using a hierarchical listbox together with a pop up window.

The hierarchical listbox may provide a unique display element that allows strings of textual data to be presented in rows, situated one atop the next. Importantly, within the listbox, any row may serve as a container for one or more other row(s), and any row may be directly contained by, at most, one row. A row that serves as a container may be “opened” or “expanded,” in which case the row(s) for which it serves as container are made visible, appearing directly below, or it may be “closed” or “contracted,” in which case the row(s) for which it serves as container are rendered hidden from view. Within the hierarchical listbox, it is possible for one row to be contained by another, which in turn is contained by another, which in turn is contained by another, and so on. The hierarchical listbox may be well suited to display relatively short strings of textual data that are arranged into single lines and are that are not arranged into paragraphs.

The term “pop up window” is used here to refer to a window that is available for viewing on demand and that contains an dit field. The pop up window may include an edit field that is well suited to display long strings of textual data that are arranged into multiple lines or, that is, that are arranged into paragraphs.

Primary data from the Tabular List may be displayed in a hierarchical listbox, while secondary data is made available for viewing within a pop up window. To do so, the software executes an appropriate Select statement “SELECT SortTag, String FROM ICD9CMVol1”

By looping through the result, information in SortTag may be used to position data from the column String into an appropriate hierarchical scheme, which is stored in memory. Within that scheme, arrays, or lists of strings, comprised of both primary and secondary data whose members are associated with other arrays, and whose members are associated with other arrays, and so on, may be provided. To display the Tabular List in a hierarchical listbox, the strings from a particular array may be identified and placed one atop the next into the listbox. In order to identify a particular array for display, information, which hereafter shall be termed “home address,” akin to that found in HomeAdress of table ICD9CMVOL1 may be provided. Initially, the array whose members have a home address consisting of exactly one numeric character (i.e. “,x” where x is any numeric character) may be identified. When this initial array has been displayed, any of its members may be opened (by the user) to reveal another array. For example, the third member of the initial array may be opened, in which case the array whose members have a home address having “3” as the first numeric character and consisting of exactly two numeric characters (i.e. “,3,x” where x is any numeric character) may be identified and displayed, one atop the next, just below the third member of the initial array. Whenever the members of an array are displayed within a hierarchical listbox, primary data associated with the members may be displayed. Secondary data, as well as data in a hidden column of the listbox providing the home addresses for the members, may not be displayed. If a member of an array has been opened to reveal the members of another array, then those members may appear directly below and may be offset to the right—to enhance the context of the now displayed array.

If a row of the listbox contains primary data ending with the predetermined character, such as an asterisk (“*”), then the data may be associated with secondary data, which is available for viewing on demand. If such a row is selected (by the user), such as by clicking on it using a suitable pointing device like a mouse, a pop up window populated both with the primary data appearing in the row and with the secondary data that properly accompanies the primary data may be displayed. To accomplish such, home address data, located in a hidden column of the selected row, may be used to identify which member of which array from the scheme stored in memory has the corresponding data. Both primary and secondary corresponding data may then be placed into the edit field of the pop up window, before calling the window into view.

In the manner described above, primary data from the Alphabetic Index may be placed into a hierarchical listbox, while secondary data is made available for viewing within a pop up window.

By placing the data from the Tabular List and the Alphabetic Index into a hierarchical listbox, wherein the user may open (expand) and close (contract) rows on demand, navigation of the data by the user is facilitated. By including various functions (such as search, locate and cross-reference functions), further facilitation of navigation of the data by the user may be achieved.

A search function may be associated with the listbox housing the Tabular List. A “wizard” for the search function may be called into view, when the user presses a “search list . . . ” button. The wizard may have a single line dit field, where the user may type a term. It may also provide “count” and “find next” buttons. It may include fields for reporting how many occurrences of the typed term have been found within the Tabular List and for reporting which of those occurrences presently is being displayed within the hierarchical listbox.

If the user, after typing a term denoted by x, presses the “count” button, then the following events may take place: (1) a pop up window, if visible, is rendered hidden. (2) Each selected row in the listbox is “de-selected”. (3) Each expanded row in listbox is collapsed. (4) An SQL select statement is formulated based upon the user desired query. (5) The SQL select statement is executed and any results are stored. The results of the select statement are the “home addresses” for those items in the Tabular List where the term denoted by x has been found. (6) The number of “home addresses” that have been stored or, in other words, the number of occurrences of the typed term is reported to the user. That number, denoted by n, may be reported as follows: Now showing _{—}0_ of _n_.

If the Tabular List appearing to the user is “unrevised,” it may contain substantially all data from the Tabular List, as published by the US Government, whereas a “revised” Tabular List (e.g. “revised for Gynecology”) contains a subset of substantially all data. A Standard Edition of software according to an aspect of the present invention may provide for an “unrevised” Tabular List, while an Enhanced Edition may provide for an “unrevised” Tabular List and, in addition, enable users to create “revised” versions of the Tabular List. Whether “unrevised” or “revised,” the Tabular List that is displayed in the hierarchical listbox can be searched in the manner described here. The SQL select statement may be formulated as: Select HomeAddress from ICD9-CMVol1 where String like x. If “unrevised,” then the SQL select statement may be formulated as: Select HomeAddress from ICD9-CMVol1 where String like ‘x’ no_case. If “revised,” then the statement may be formulated as: Select HomeAddress1 from ICD9CMVol1 WHERE OnOff1=‘1’ and String like ‘x’ no_case.

To further illustrate, consider the following example, where the Tabular List appearing to the user is “unrevised” and where the user, after typing the key word “cholera,” has pressed the “count” button. In this example, after the SQL select statement is formulated and executed, the following home addresses are stored: ,1,1,1; 1,1,1,1; 1,1,1,2; ,1,1,1,3; ,17,24,19,3; ,18,1,1,1; ,18,1,2,1; ,18,1,3,1; ,18,1,6,1; ,18,9,5,1; ,19,18,19,3; ,19,21,10,7.

Since twelve addresses are stored, the user is informed that there are twelve locations in the Tabular List where the key word has been found: “Now showing _{—}0_ of _{—}12_”.

If the user presses the “find next” button, then the following events may occur. (If the user has not already pressed the “count” button, then events 1-6, described above, occur first, before the following events.) (7) The data referenced by the first of the stored home addresses may be revealed in the listbox and then is selected. The data need not be revealed, if it has a home address consisting of exactly one numeric character (i.e. “,x” where x is any numeric character), because all data having such a home address already have been revealed within the rows of the listbox. The data may be revealed, however, if it does not have such a home address. In this case, informed by the home address, the data is revealed as the appropriate rows in the listbox expand automatically. Let's say the home address is “,1,5,3,8.” In this case, the data is revealed as the following rows are expanded: the first (1) row is expanded, revealing a second tier of rows, and then the fifth (5) row of the second tier is expanded, revealing a third tier of rows, and then the third (3) row of the third tier is expanded, revealing a fourth tier of rows. Within the fourth tier of rows, the referenced data is present in the eighth (8) row. Next, the referenced data is selected. As set forth previously, if the selected data ends with the predefined character, such as an asterisk, then as it is selected, a pop up window is brought forward to display additional data. (9) The user is informed that the first of the total number of locations for the key term has been revealed, such as by displaying “Now showing _{—}1_ of _n_” where n is the total number of locations.

Each additional time the user presses the “find next” button, the following events may occur. (8) Pop up window, if visible, is rendered hidden. (9) Each selected row in listbox is “de-selected”. (10) Each expanded row in listbox is collapsed. (11) The data referenced by the next of the stored home addresses is revealed in the listbox and then is selected, and the user is informed that the next of the total number of locations for the key term has been revealed. If the user presses the “find next” button but either a stored home address does not exist or all stored home addresses already have been revealed, then a “beep” sounds and any stored home addresses are cleared. In the event that a “beep” sounds, the fields used for reporting which occurrence of key term is revealed and for reporting how many occurrences of key term exist are cleared (“Now showing ______ of ______”).

A locate function is associated with the listbox housing the Alphabetic Index. The function has a single line edit field, which receives input from the user's keyboard and has a “clear” button, which when pressed causes the text within the edit field to read as “ ”. The function allows the user to automatically locate an item within the Alphabetic Index, simply by typing it. Whenever the text within the edit field changes, events are executed. If the text changes, such that it reads as “ ”, then all rows in the listbox are collapsed and any selected rows are “de-selected.”

If the text within the edit field changes otherwise, then events proceed as follows. If more than one row in the listbox is selected, then all selected rows are de-selected. If the text changes but still matches the leftward portion of the text in a presently selected row, then these events stop. Otherwise, they proceed as follows. (12) If the text changes, such that it does not read as a letter (e.g. “A”) or, in other words, such that it has a length greater than one character, then the last selected row is collapsed. (13) The last selected row is “de-selected”. (14) The first appearing row, having text the leftward portion of which exactly matches the text within the edit field, is revealed by scrolling the listbox appropriately, is selected and is expanded.

A cross-reference function may be provided that is associated with the listbox housing the Alphabetic Index. To use this function, the user need only select a row in the listbox and then press the “get cross-reference” button. When the user presses the button, if the selected row has data ending with a numeric or alphanumeric code, then the software displays the listbox housing the Tabular List, where it reveals and selects the row whose data is directly associated with the code. In this manner, the software provides the appropriate cross-reference.

When, after selecting a row in the listbox housing the Alphabetic Index, the user presses the “get cross-reference” button, the following events may take place. (15) An SQL select statement is formulated. If the Tabular List appearing to the user is “unrevised,” then the SQL select statement is formulated as: “SELECT HomeAddress FROM ICD9CMVOL1 WHERE String LIKE ‘\A″+x+’“,” where x is the numeric or alphanumeric code from the selected row.

If the select statement yields a result, i.e. a home address, then the following events may be executed. (16) The listbox housing Alphabetic Index is hidden. (17) The listbox housing Tabular List is revealed. (18) Each selected row in listbox is “de-selected”. (19) Each expanded row in listbox is collapsed. (20) The data referenced by the home address is revealed—in a manner analogous to that described under “Find Next Button”—and then is selected.

As set forth, the present invention may be realized utilizing the commercially available Valentina database for functionality associated with the Tabular List and the Alphabetic Index from ICD9-CM. The Valentina database engine combines features of two industry standard database models, “relational” and “network,” and adds some new features. Valentina's Object-Relational (OR) data model is an extension of the traditional Relational data model. The OR data model contains the Relational model as an exact subset. According to an aspect of the present invention, there may be provided three database tables, the ICD9CMVOL1 table, the ICD9CMVOL2, and a third table.

Within the Alphabetic index and within the category “N” is a subcategory whose primary data is given as “Neoplasm, neoplastic” and whose secondary data is itself organized into a hierarchical scheme. This secondary data is stored in the table, listed as the third table (e.g., “Table—3.”) If the user goes to the Alphabetic Index and, more specifically, to the rows beneath the letter “N,” and selects the row whose text reads “Neoplasm, neoplastic*,” then the secondary data from “Table—3” may be harvested and revealed—not in a pop up window but rather—in a pop up listbox. If the user then selects a row in the pop up listbox, then, in the event that such data exists, supplementary data is revealed in a pop up window.

According to an aspect of the present invention, the ICD9CMVOL1 table may include the following fields: SortTag, String, HomeAddress, HomeAddress1, HomeAddress2, HomeAddress3, HomeAddress4, HomeAddress5, OnOff1, OnOff2, OnOff3, OnOff4 and OnOff5.

The OnOffx columns, together with the HomeAddressx columns, where x is a number from 1 to 5, may be associated with “revised” versions of the Tabular List, which may be created within an Enhanced Edition of software according to an aspect of the present invention. A given OnOffx column (e.g. OnOff1) indicates which records in the table ICD9CMVOL1 are associated with a particular “revised” Tabular List. If, for a given record, the OnOffx field shows “0,” then the data from the String column of the record ought not be included within the “revised” Tabular List, but if the column shows “1,” then the data should be included there. Further if, for a given record, the OnOffx column shows “0,” then the corresponding HomeAddressx column is left blank, but if the OnOffx column shows “1,” then the corresponding HomeAddressx column provides a “home address” for the data from the String column of the record.

According to an aspect of the present invention, the ICD9CMVOL2 table may include the following columns: SortTag and String. According to an aspect of the present invention, the third table may include the following columns: SortTag and String.

The following Table 1 shows a first eight records (rows) in table ICD9CMVOL1 according to an aspect of the present invention, where ST=SortTag, HA=HomeAddress and OO=OnOff.

TABLE 1

| ST | String | HA | HA1 | HA2 | HA3 | HA4 | HA5 | OO1 | OO2 | OO3 | OO4 | OO5 |
|---|---|---|---|---|---|---|---|---|---|---|---|---|
| 1 | ″01. INFEC | ,1 | ,1 | ,1 | ,1 | ,1 | | 1 | 1 | 1 | 1 | 0 |
| 2 | ″INTESTIN | ,1,1 | ,1,1 | | ,1,1 | ,1,1 | | 1 | 0 | 1 | 1 | 0 |
| 3 | ″001 Cholera | ,1,1, | | | ,1,1, | ,1,1, | | 0 | 0 | 1 | 1 | 0 |
| | | 1 | | | 1 | 1 | | | | | | |
| 4 | ″001.0 Due t | ,1,1, | | | | | | 0 | 0 | 0 | 0 | 0 |
| | | 1,1 | | | | | | | | | | |
| 4 | ″001.1 Due t | ,1,1, | | | | ,1,1, | | 0 | 0 | 0 | 1 | 0 |
| | | 1,2 | | | | 1,1 | | | | | | |
| 4 | ″001.9 Chole | ,1,1, | | | | ,1,1, | | 0 | 0 | 0 | 1 | 0 |
| | | 1,3 | | | | 1,2 | | | | | | |
| 3 | ″002 Typhoi | ,1,1, | ,1,1, | | ,1,1, | | | 1 | 0 | 1 | 0 | 0 |
| | | 2 | 1 | | 2 | | | | | | | |
| 4 | ″002.0 Typh | ,1,1, | ,1,1, | | ,1,1, | | | 1 | 0 | 1 | 0 | 0 |
| | | 2,1 | 1,1 | | 2,1 | | | | | | | |

As will be evident to one of ordinary skill in the pertinent arts, the fields in columns SA, String and HA are constant. Further, the fields in columns HA1, HA2, HA3, HA4, HA5, OnOff1, OnOff2, OnOff3, OnOff4, OnOff5 are variable and are determined by user upon creating revised versions of Tabular List.

The following illustrates a first eight records in column String of table ICD9CMVOL1.

“01. INFECTIOUS AND PARASITIC DISEASES (001-139)*###”+chr(13)+chr(13)+“Note: Categories for ‘late effects’ of infectious and parasitic diseases are to be found at 137-139.”+chr(13)+chr(13)+“Includes: diseases generally recognized as communicable or transmissible as well as a few diseases of unknown but possibly infectious origin”+chr(13) +chr(13)+“Excludes: acute respiratory infections (460-6)”+chr(13)+“carrier or suspected carrier of infectious organism 02.0-V02.9)”+chr(13)+“certain localized infections”+chr(13)+fluenza (487.0487.8)”.

“INTESTINAL INFECTIOUS DISEASES (001-009)*###”+chr(13)+(13)+“Excludes: helminthiases (120.0-129)”.

“001 Cholera”

“001.0 Due to Vibrio cholerae”

“001.1 Due to Vibrio cholerae el tor”

“001.9 Cholera, unspecified”

“002 Typhoid and paratyphoid fevers”

“002.0 Typhoid fever*###”+chr(13)+chr(13)+“Typhoid (fever) fection) [any site]”

The following Table 2 illustrates a first eight records (rows) in table D9CMVOL2.

TABLE - 2

| SortTag | String |
|---|---|
| 1 | “A” |
| 2 | “AAV (disease) (illness) (infection) - see Human |
| | immunodeficiency virus (disease) (illness) (infection)” |
| 2 | “Abactio - see Abortion, induced” |
| 2 | “Abactus venter - see Abortion, induced” |
| 2 | “Abarognosis 781.99” |
| 2 | “Abasia (-astasia) 307.9 |
| 3 | “atactica 781.3” |
| 3 | “choreic 781.3” |

As will be evident to one possessing an ordinary skill in the pertinent arts, fields in column SortTag and String are constant.

The following Table 3 illustrates a first eight records (rows) in third table.

TABLE - 3

| Sort Tag | String |
|---|---|
| 1 | “A” |
| 2 | “abdomen, |
| | abdominal@@@195.2@@@198.89@@@234.8@@@2 |
| | 29.8@@@238.8@@@239.8” |
| 3 | “cavity@@@195.2@@@198.89@@@234.8@@@229.8 |
| | @@@238.8@@@239.8” |
| 3 | “organ@@@195.2@@@198.89@@@234.8@@@229.8 |
| | @@@238.8@@@239.8” |
| 3 | “viscera@@@195.2@@@198.89@@@234.8@@@229. |
| | 8@@@238.8@@@239.8” |
| 3 | “wall@@@173.5@@@198.2@@@232.5@@@216.5@ |
| | @@238.2@@@239.2” |
| 4 | “connective tissue@@@171.5@@@198.89@@@- |
| | @@@215.5@@@238.1@@@239.2” |
| 2 | “abdominopelvic@@@195.8@@@198.89@@@234.8@ |
| | @@229.8@@@238.8@@@239.8” |

As will be evident to one possessing an ordinary skill in the pertinent arts, fields in columns SortTag and String are constant.

According to an aspect of the present invention, a second database may be provided and used for custom lists. A “custom list,” which may be created not (necessarily) as a subset of the Tabular List, which has a hierarchical scheme with just three levels, which is displayed in its own listbox entitled Custom List, and whose data is stored within various tables of a REALbasic database is to be distinguished from a “revised” Tabular List, which is created as an exact subset of the “unrevised” Tabular List, which has a hierarchical scheme with up to five levels, which is displayed in place of the “unrevised” Tabular List, and which is stored in the table ICD9CMVOL1 of a Valentina database.

The following database structure may be used to provide for functionality associated with user-defined custom lists.

a. Database Tables

i. CustomLists

ii. CustomList1

iii. CustomList2

iv. CustomList3

v. CustomList4

vi. CustomList5

vii. StoredCategories1

viii. StoredCategories2

ix. StoredCategories3

x. StoredCategories4

xi. StoredCategories5

xii. StoredSubCategories1

xiii. StoredSubCategories2

xiv. StoredSubCategories3

xv. StoredSubCategories4

xvi. StoredSubCategories5

b. Database Tables and Columns

i. CustomLists

Rank

Translated Name

UserDefinedName

ii-vi. CustomListX

DiseaseName

DiseaseCode

DiseaseCategory

DiseaseSubCategory

CategoryRank

SubCategoryRank

CodeInstance

vii-xi. StoredCategoriesX

Category

Rank

xii-xvi. StoredSubCategoriesX

Category

SubCategory

Rank

Tools for creating custom lists may be provided in a separate window, whose hierarchical listbox aptly is entitled Custom List. The tools may provide for five lists, each organized into three levels (i.e. category, subcategory, disease plus code). The lists may be displayed within the hierarchical listbox, or they may be exported to any suitable application, such as Microsoft® Excel®, in which case several formatting options may be provided. These options provide that the lists, when they arrive in Excel®, will appear either as outlines or tables and will be suited for print either as full-page or pocket-sized documents or, alternatively, will be suited for display on a handheld data assistant (e.g. Palm@). To learn the steps necessary to create and export a custom list, the user need only press the button (“?”) that appears in the lower section of the window.

Tools relating to revised versions of the Tabular List may be presented in a window whose hierarchical listbox houses the Tabular List itself. To access the tools, a user may “click” over a red triangle located just above the upper left corner of the listbox. From the menu that appears, the user may select edit list. A small window, or “wizard,” may appear. The user may simply follows the steps, as described in the wizard, to create or edit a revised version of the Tabular List.

According to an aspect of the present invention, both the Alphabetic Index and the Tabular List may be searched for occurrences of terms using the above-identified tools and functions. This represents a significant advancement in the art.

According to an aspect of the present invention, data corresponding to row entries may be exported to other applications, such as applications for storing patient records or generating billing information. This may be achieved by providing a button that may be selected to copy the selected text entry in an active listbox to a clipboard, or by enabling a right-click to copy function, for example.

According to an aspect of the present invention, data indicative of user selections may be captured and stored for later analysis by data mining for example. For example, statistical data of medical diagnosis code lookups may be captured and stored to compare a particular physicians rate of diagnosing a particular condition versus national or regional rates, for example. Further, data indicative of many medical providers usage of the system and method to lookup diagnosis codes may be captured. This cross-physician data may help aid the early detection of medical crises, such as an outbreak of a disease that is easily misdiagnosed in individual circumstances, but which collectively provide a possible indication of misdiagnosis, such as skin rashes for example. Such recognition may be expedited due to the relatively instantaneous availability of the raw data as compared to looking at conventional billing records, for example.

According to the present invention, the present system and method may be provided as stand-alone applications, or in a client-server environment wherein a system owner may operate as a application service provider (ASP), for example. Connectivity may be provided via the global interconnection of computing devices and computing networks commonly referred to as the Internet. Such a client-server environment may serve to facilitate data mining, although such is clearly not required.

The present invention presents, in an electronic format, an accurate and efficient program that may utilize the Tabular List of Diseases and the Alphabetic index to Diseases from the International Classification of Diseases, 9th Revision, Clinical Modification (ICD9-CM), to provide viewing, navigation, searching, and cross-referencing for the proper identification of diseases and/or medical conditions plus corresponding codes, such as for medical practice documentation.

The invention places the information from the Tabular List and Alphabetic Index in at least one database, and provides for harvesting the information from the database and for displaying it in a hierarchical scheme, such as by computer programming.

FIG. 1 is a screen shot illustrating a window provided by the present invention. FIG. 1 specifically displays a Tabular List heading 100 corresponding to a paper copy of the ICD9-CM Tabular List. A hierarchical list box 102 is displayed to the user in order to more efficiently utilize the categories presented. The hierarchical listbox is an appropriate vehicle for data that exhibits multiple levels of organization and, between the levels, strict parent-to-child relationships, because the hierarchical listbox allows items within a given level to serve as “containers” for items within successive levels. The hierarchical listbox has multiple rows wherein strings of textual data reside. Each of the rows affords a line for textual data. Within the hierarchical listbox, a row may serve as a container for one or more other rows, yet every row may be contained by, at most, one row.

For a given row of the listbox, the text therein represents the primary part of a string of textual data from the Tabular List. In an exemplary embodiment, if the text is from level 1, it may be positioned at the left margin of the listbox, and if it is from level 2, then it may be positioned a fixed distance rightward of the text from level 1, and so on. Moreover, the use of a hierarchical listbox ensures improved viewing and ease of navigation through vast amounts of data, such as that in the ICD9-CM listing. The present invention preferably provides that items serving as “containers” may be opened or closed at will, using standard software control methodologies, such as using a trackball, touch screen, light-pen or mouse to engage in a standard “point and click”, double click, and/or drop down menu methodology.

The hierarchical listbox may include a title e.g. Tabular List. The listbox may include directional scroll bars, such as vertical 112 and horizontal 114 scrollbars, that enable the user to bring into view any items that extend beyond the limits of the listbox. Proximate to the vertical scrollbar, such as above the scrollbar, buttons may be present 116, the activation of which buttons may allow the user to adjust text size within the listbox. Items that appear within the listbox may serve as containers for other items, thus allowing for the hierarchically expanded levels of organization discussed hereinabove.

Upon the display of the Tabular List 100 using the hierarchical listbox 102, disease categories may act as containers for disease subcategories, which in turn may act as containers for disease entities, which in turn may act as containers for more specific disease entities, for example. A container may be opened or closed to display different levels of organization. An open container may display lower tier organizations as discussed hereinabove. If all of the items serving as containers are closed, the Tabular List may be contracted to the highest level in the hierarchy, such as the 19 disease categories. Alternately, if all of the items serving as containers are opened, the Tabular List of FIG. 1 may be expanded to multiple thousands of disease categories, subcategories and entities. By opening only those container items that are of interest, a particular disease entity and its corresponding numeric code may be located quickly and viewed within proper context.

If a given item acts as a container, it is preferably identified as such by the presence of a disclosure symbol 104, such as, for example, a triangle, to thereby mark the item as having an organization below the current level. To open or close the item, the user may “point and click”, or otherwise select, the disclosure symbol. When the item is opened, the disclosure symbol may change orientation, such as, for example, wherein a triangle is used as the disclosure symbol, which triangle becomes rotated upon opening. If any item (row) in the listbox has been opened, then a button marked “<<” may appear just above the right side of the listbox. When this button is pressed, any item or items within the listbox that already have been opened are closed automatically. Alternatively, when the mouse is used to “double click” within the region bordering the listbox, likewise any item or items that already have been opened are closed automatically.

Whereas the primary parts of the strings of textual data from the Tabular List are presented in the rows of the listbox, any secondary parts of those strings, not necessarily being suited for display within the rows of the listbox, are available to be viewed together with the primary parts within a pop up window. If a given primary part is accompanied by a secondary part, then the primary part, as it appears in a row of the listbox, is appended with an asterisk 118. Selection of a row whose text is a primary part ending with an asterisk causes the display of a pop up window containing a multilined edit field, whose text includes the primary part appearing in the selected row as well as the corresponding secondary part. Removal of the selection, which may result when the mouse is used to “single click” within the region bordering the listbox or which may result when another item is selected, causes concealment of the pop up window.

A hierarchical listbox and pop-up window(s) may be used to display the information from the Alphabetic Index, in a manner analogous to the manner described hereinabove with respect to the Tabular List.

The present invention may additionally supplement the ICD9-CM Tabular List and Alphabetic Index with advanced features. These features may include search, locate and cross-reference functions. The search function may accompany the Tabular List displayed in the listbox 102 shown in FIG. 1, and may allow the user, after entry of a key word or phrase, to learn instantly the number of occurrences of the key word and, if desired, to review, in serial fashion each of the occurrences. The locate function may accompany the Alphabetic Index and may provide the user an edit field in which to type. Each time the user types a character into the edit field to form a string, if the string matches the beginning of any string of textual data organized into level 1 or level 2, the row of the listbox containing the first such located string may be displayed automatically such as by opening rows in the listbox, scrolling within the listbox, and/or selecting the row that contains the located string. The cross-reference function also may accompany the Alphabetic Index and may allow the user to move instantly and automatically from a selected item in the Alphabetic Index to a corresponding item in the Tabular List.

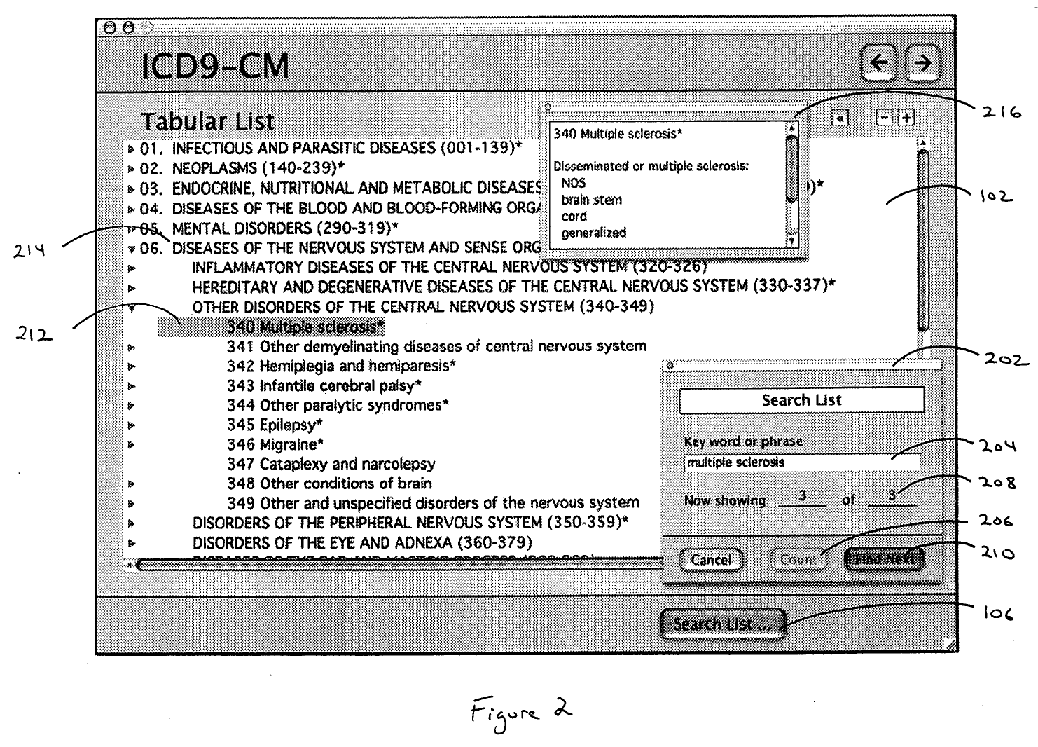

Referring now to FIG. 2, upon electronically depressing the search list button 106, a search list dialog box is displayed 202 that allows the user to type in a key word 204 to be used in the search of the Tabular List. After keyword entry, depressing the count key 206 may cause the illustration of the total number of occurrences of the keyword in the Tabular List 208. Further, by depressing the find next button 210, the list box may move to the next occurrence of the keyword in the list. The user may thereby proceed to view all of the keyword entries in the Tabular List until the user decides that the appropriate entry has been located. As seen in FIG. 2, the term multiple sclerosis 204 has been illustratively entered, and three entries 208 for that term have been identified in the Tabular List appearing in the listbox 102. The user has illustratively moved to the third entry by depressing the find next button 210, and the third entry is shown highlighted 212 in the listbox 102. The entry falls under the category of Diseases of the Nervous System and Sense Organs 214, and thus the container is opened wherein the first three subcategories of this category 214 are shown as inflammatory diseases of the central nervous system, hereditary and degenerative diseases of the central nervous system, and other disorders of the central nervous system. The third subcategory has been opened to reveal the item multiple sclerosis, which has been selected 212. Because this item is marked with an asterisk, upon selection of this item, a pop-up window displaying useful information has been automatically presented 216. Note that the search list function 202 and the pop-up information window 216, may preferably be activated, closed, or moved using standard select and drag mouse techniques, so that the Tabular List may be easily viewed and manipulated. Note also that the pop-up window may be resized using standard mouse drag techniques. The pop-up window feature may accompany both the Tabular List and Alphabetic Index. The pop-up window may be designed to provide the user with peripheral information associated with an item in the hierarchical listbox that does not readily fit within the framework of the listbox. The user may, for example, be made aware that such peripheral information exists for a particular item by the presence of an asterisk in the line item of the disease within the listbox, as set forth hereinabove. In order to view the pop-up information, the user may select, or highlight, the line item having the asterisk associated therewith.

In an exemplary embodiment, the invention may provide a search function for the Tabular List. A button marked “Search List . . . ” is found along with the hierarchical listbox that displays the information from the Tabular List. When the button is pressed, a window associated with the search function is brought into view. The window may have a single line edit field, which receives input, and includes buttons marked “Cancel, “Count” and “Find Next.” The user may type a word or phrase, or portion thereof, into the edit field. To count the number of occurrences of the typed word or phrase, the coder may press the “Count” button, after which appears a number, e.g. 22, in the space indicated: “Now showing of ______ 22.” This number represents the number of occurrences of the typed word or phrase among the strings of textual data from the Tabular List. To view, in serial fashion, each of the occurrences, the user may press the “Find Next” button. Each time the user presses the “Find Next” button, the next successive occurrence of the key word or phrase is displayed. Hence the third time the coder presses the button, the line of text in the window reads: “Now showing 3 of 22 .” Each time an occurrence is displayed, all rows in the listbox may be closed. Particular rows, those that must be opened to reveal the key word or phrase, are opened. The row associated with the string containing the key word or phrase is selected. The search function looks for occurrences of the key word or phrase among both the primary and secondary parts of strings from the Tabular List.

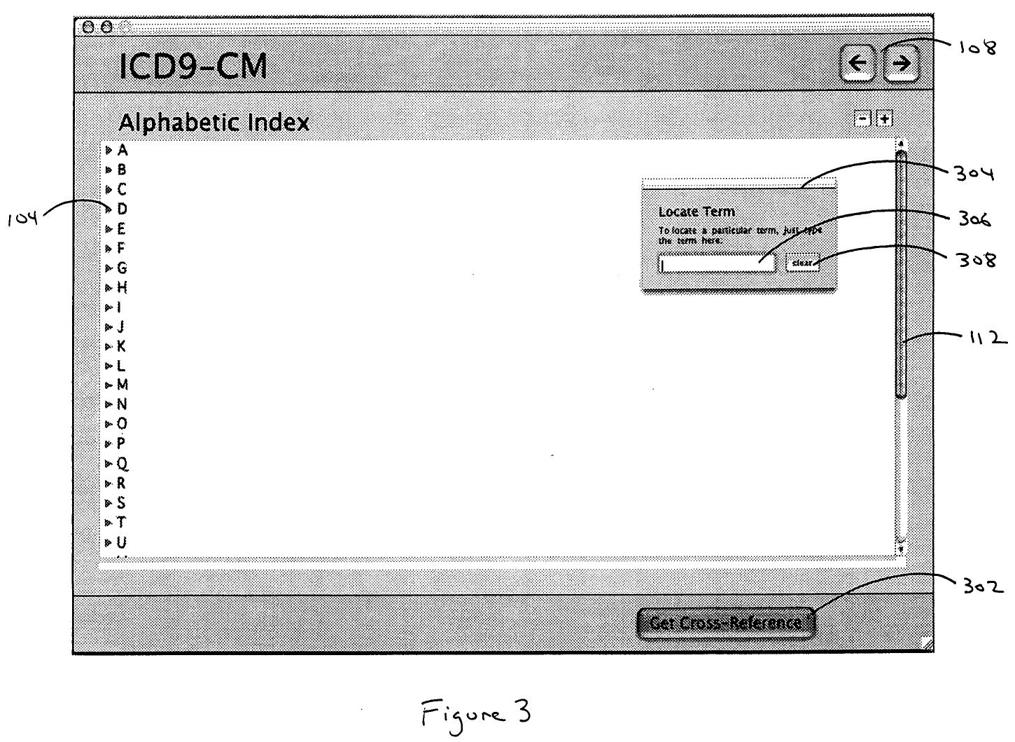

Returning now to FIG. 1, the Alphabetic Index may be generated by any of several means, such as by depressing arrow button 108. After release of button 108, the list box 102 may change to that of the Alphabetic Index, as shown in FIG. 3. The listbox of the Alphabetic Index displays letters from a to z. Each letter is a container, which may be opened or closed by pressing the disclosure element 104 proximate to each letter. A locate function 304 may be available for use with the Alphabetic Index and may be contained in a small window having a single line edit field 306 and having, beside the edit field, a button 308 marked “clear.” To utilize the locate function, the user need only type letters into, or delete letters from, the edit field 306. Each time a letter is typed or removed, the first appearing item from level 1 (letter) or level 2 (word or phrase) within the listbox whose leftward portion exactly matches the typed letter(s) is revealed and selected, and, if the row containing that item has a disclosure element, then the row is opened. But before these events take place, the last selected item is “de-selected” and, unless the last selected item is a letter (“A” or “B” or “C” etc), the row of the last selected item is closed. By pressing the clear button 308, the user may remove all text from the edit field and may close all rows within the listbox. A cross-reference function may be available for use with the Alphabetic Index. In order to utilize the cross-reference function, the user may select an item within the Alphabetic Index and then may press the “Get Cross-reference” button 302, after which the user may be shown automatically the corresponding item in the Tabular List.

As indicated, a button 302 marked “Get Cross-reference” may be found along with the hierarchical listbox that displays the information from the Alphabetic Index. The button may be pressed after a term has been located, and after the row containing the term has been selected. When the button is pressed, the listbox containing the Alphabetic Index may be removed from view, and the listbox containing the Tabular list may be brought into view and automatically manipulated. All rows in the listbox may be closed, except those needing to be opened to reveal the condition corresponding to the cross-referenced term, which are opened. The row containing the condition may be selected. If the selected row contains text followed by an asterisk, then a pop-up window may be brought into view as discussed hereinabove.

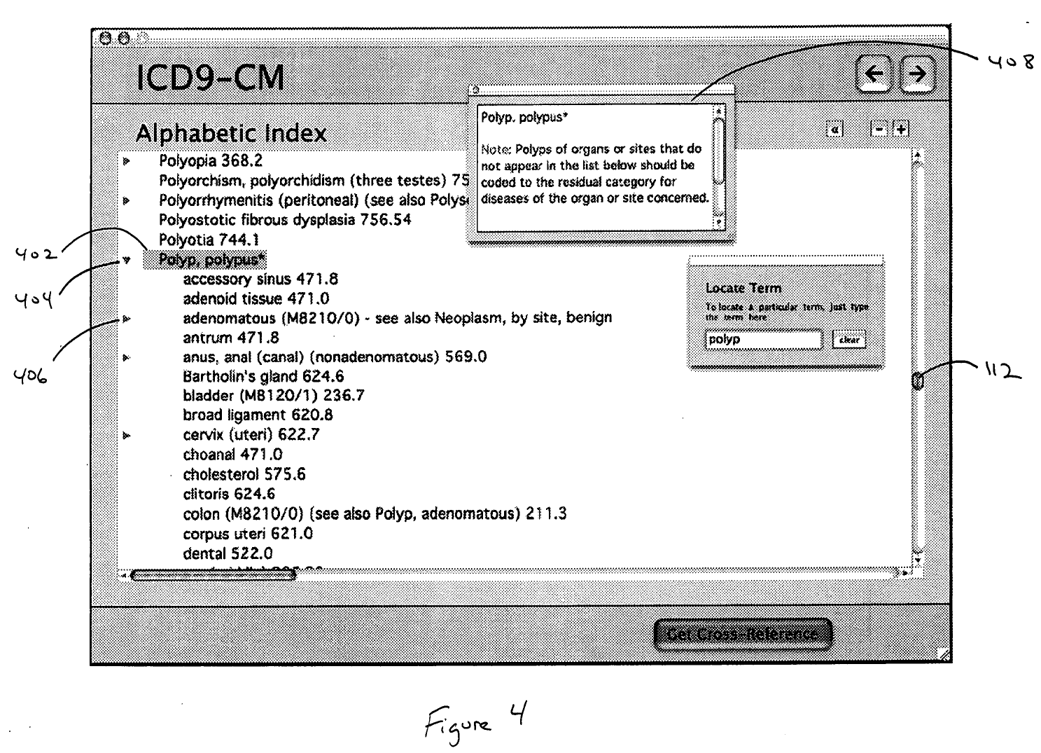

In an exemplary embodiment, it is assumed that a primary caregiver discovers a polyp within the nasal cavity of a patient. In order to determine the proper disease code for the patient, the caregiver opens the program and moves to the window containing the Alphabetic Index, such as by depressing the arrow key 108 of FIG. 3 until the Alphabetic Index listbox appears. There, the caregiver simply begins to type the word “polyp.” As each letter appears within the edit field of the locate function, the appropriate item in the listbox is revealed and selected (first, the letter “p” is revealed and selected, then the word “pocket(s),” then the phrase “policeman's disease,” then the word “polyadenitis,” and finally the words “polyp, polypus.”) and, if the item is in a row serving as a container, then, after being selected, the row of the item is opened or expanded. In this manner, as depicted in FIG. 4, the caregiver efficiently locates the item “polyp, polypus,” and selects and opens the row of this item, to reveal the items contained within. Because the word polyp is followed by an asterisk, as the word polyp is selected, a pop-up window 408 is called forward to provide supplementary information. The word polyp 402 is displayed as an opened container, indicated by the rotated position of the disclosure element 404 and by the items located directly below and offset to the right. Hence there is a level of organization below the word polyp. Thus, accessory sinus, adenoid tissue, adenomatous, etc are sub-levels in this hierarchy. Also, as indicated by the presence of a disclosure element 406 to the left of the word adenomatous, there is a lower level tier for that term.

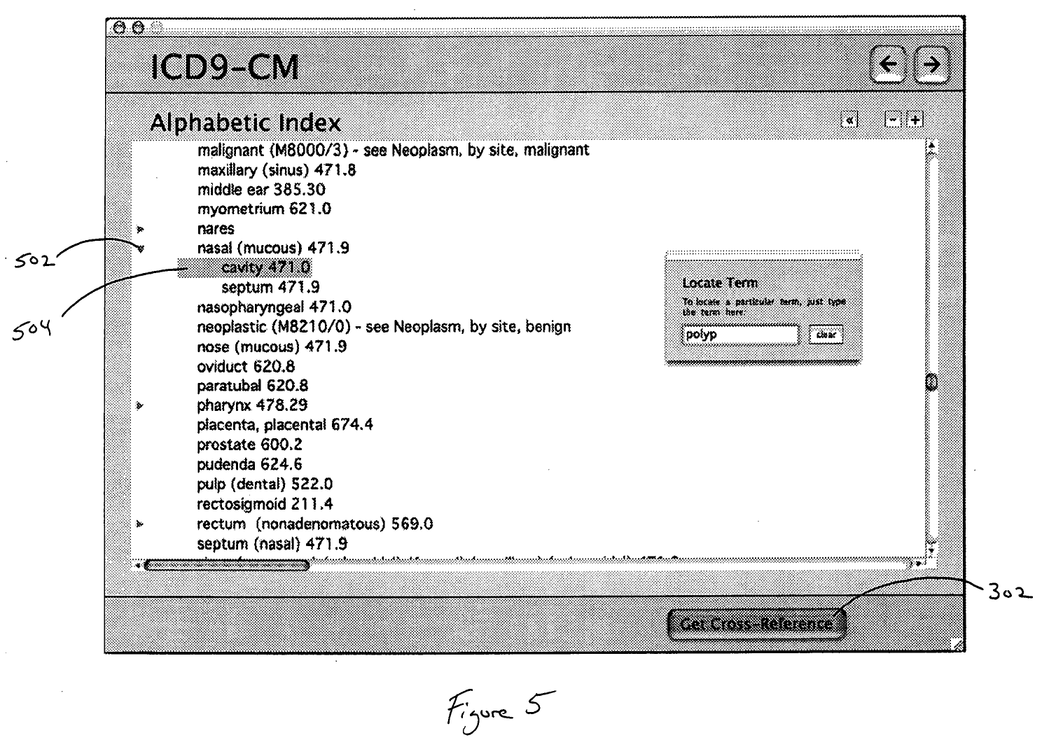

Due to the specific interest, in this non-limiting example, in a nasal polyp, the caregiver may use the scroll bar 112 to move down the list in search of the sub-level for the nasal type of “polyp”. FIG. 5 illustrates a screen shot of the results of the successful search for the nasal type of polyp. Note that the word nasal has a disclosure element 502 that, when pressed by the user, reveals the sub-categories of the word nasal, namely cavity and septum. In the non-limiting example of FIG. 5, the caregiver may locate, among the information under nasal, the word cavity and the numeric code 471.0. After selecting this word and code 504, the caregiver may depress the “get cross-reference” button 302 and be moved automatically to the Tabular List, wherein the category Diseases of the Respiratory System has been opened.

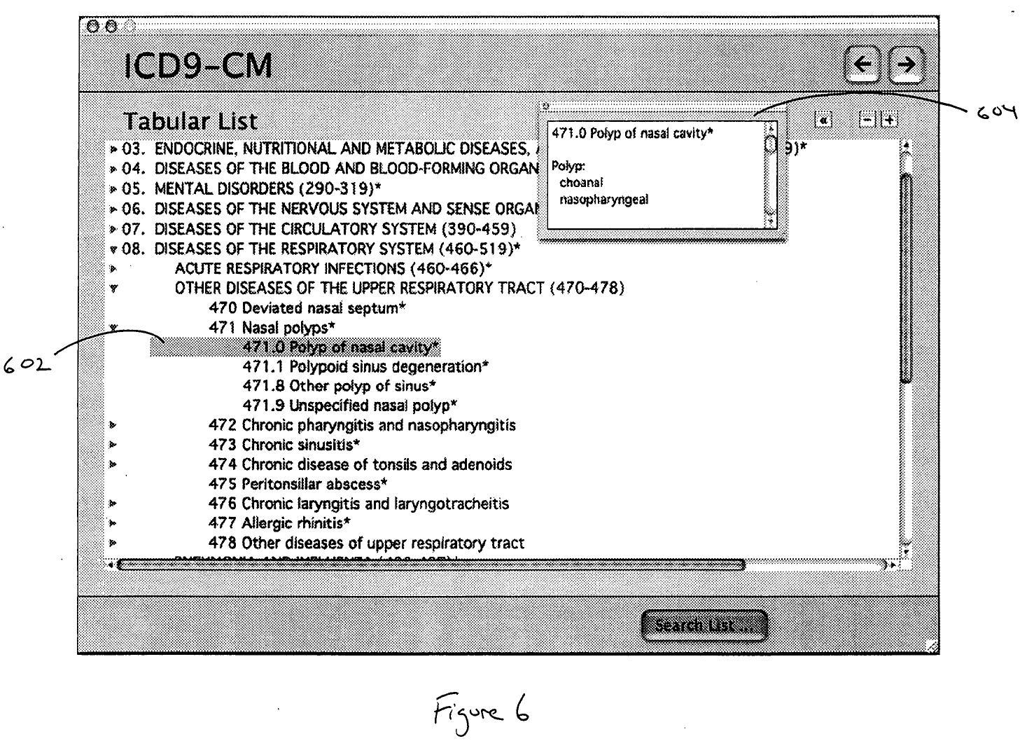

FIG. 6 is a screen shot illustrating the exemplary results of a cross reference button 302 selection in FIG. 5. Note, with reference to the non-limiting example of FIG. 6, that the category “diseases of the respiratory system” has been opened and that the subcategory “other diseases of the upper respiratory tract” has been opened. Additionally note that the disease entity “nasal polyps” has been opened, revealing the more specific entity “polyp of nasal cavity,” which has been selected 602. When this entity was selected, since this entity is followed by an asterisk, a pop-up window 604 was generated to provide supplementary information related thereto.

The caregiver may review the selected entity 602 along with the supplementary information 604. Importantly, the caregiver may also review each of the items that have been opened (i.e. disease category, subcategory and entity), along with any supplementary information accompanying them. After reviewing them, the caregiver may determine that the disease entity selected by the cross-reference function is appropriate for the patient.

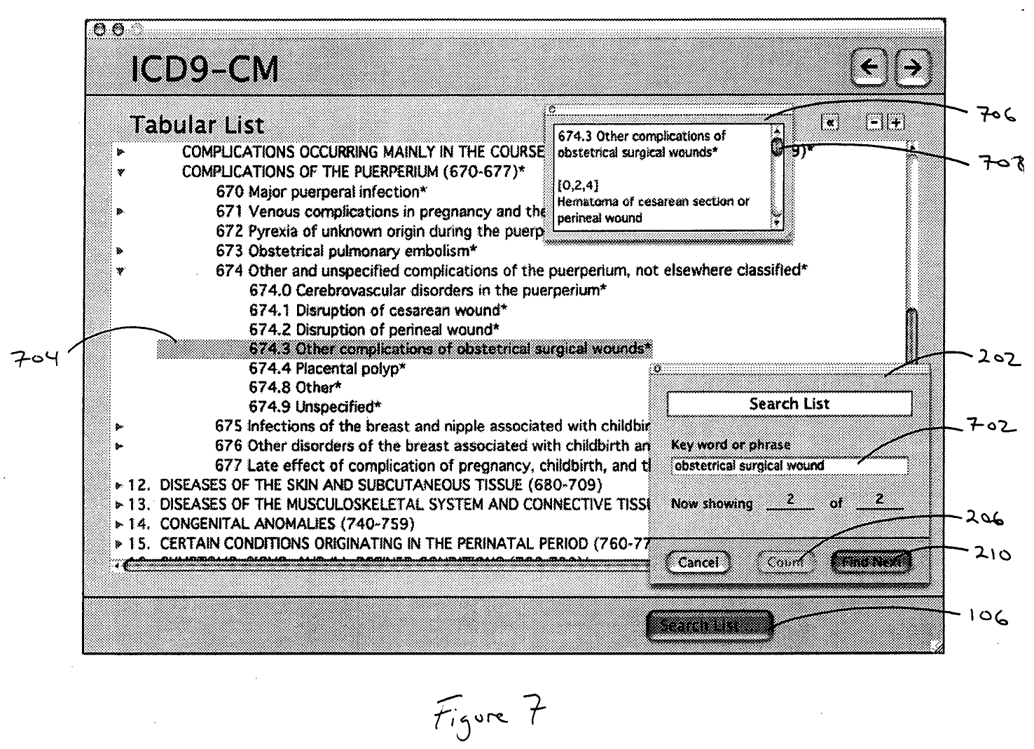

Searches for the correct ICD9-CM codes may be performed in a variety of ways to accommodate varying levels of knowledge of the disease being searched. For example, the caregiver/user may perform wound care on a patient for which a cesarean section wound has become infected following surgery. In an attempt to locate the appropriate disease code for this patient, the caregiver has opened the ICD9-CM search program, as in FIG. 1, has gone to the window housing the Alphabetic Index by depressing the listbox change window control button 108, and has searched for, but not found, a reference relating to obstetrical surgical wound. At this point, the user may move back to the window housing the Tabular List by selecting the arrows 108, thereby allowing selection of either the Alphabetical Index or the Tabular List. Referring now to FIG. 7, once in the Tabular List, the caregiver may call the search function by pressing the appropriate button 106 and then may enter the phrase obstetrical surgical wound 702. By pressing the “count” button 206 associated with the search function dialog box, the caregiver/user may learn that two occurrences of the phrase exist. By pressing the “find next” button 210, the user is shown the location of the first occurrence, and by pressing the button again, is shown the location of the second occurrence. After reviewing the location of the second occurrence, the caregiver may determine that the second occurrence provides a disease entity and code suited to the patient. In the non-limiting example of FIG. 7, the selected item 704, other complications of obstetrical surgical wounds, contains an asterisk and so a pop up window has been brought forward to display additional information 706. The pop up window has there within additional information pertaining to other complications of obstetrical surgical wounds and includes a scroll bar 708 to allow viewing of information that does not fit within the pop up window. It should be noted that both the pop up window 706 and the search list box 202 may be moved on the display by simply placing the mouse cursor over the title bar and using click and drag methodologies.

In one embodiment of the invention, which may be referred to as the Enhanced Edition, the present invention may also include the capability to create and manipulate a multiplicity of custom lists. Up to five custom lists may be generated in an exemplary embodiment, although any number of lists may be generated, dependent upon memory availability and the like, as will be apparent to those skilled in the art. By default, a custom list may be organized into three levels, including, for example, category, subcategory, and disease plus code, and is ideally suited as a coding resource for commonly encountered diseases. The user, after creating a custom list, may choose to display the custom list within the hierarchical listbox, or may choose to export it to Microsoft® Excel®, in which case several formatting options may be available. These formatting options may provide that the list, upon exportation to Excel®, appear as an outline or table suitable for print as a full-page or pocket-sized document, for example, or, alternatively, suitable for display on a PDA, such as, for example, a Palm Pilot®.

In one embodiment, the invention may provide for the capability to create custom lists of commonly used codes that a healthcare provider regularly uses in practice. This capability may be particularly useful in medical specialty areas, for example. In order to utilize this capability, the healthcare provider or other user of the software may open the software and move to the window for which the listbox has the title Custom List. This may be accomplished by depressing a suitable navigation button 108.

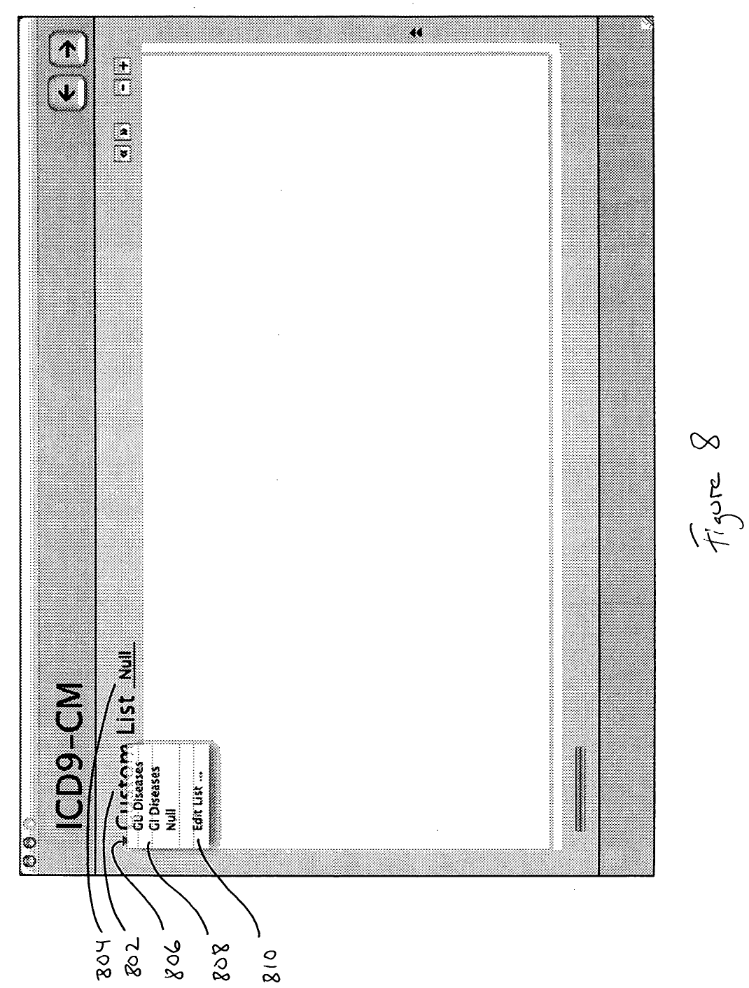

FIG. 8 illustrates a screen shot of an exemplary window for custom lists. The general title 802 for the listbox is Custom List, indicating that a custom list may appear in the listbox. A particular title 804 for the listbox, used to indicate the particular custom list that appears in the listbox, appears to the right of the general title. A large triangle 806 pointing downward appears to the left of the general title. By pressing the triangle 806, the user calls forward a menu 808 that lists all available custom lists, including the “null” list, and additionally that lists the phrase “edit list . . . .” The user may select any custom list appearing in the menu and, by doing so, may cause that list to appear in the listbox. Alternatively, the user may select the phrase “edit list . . . ” 810.

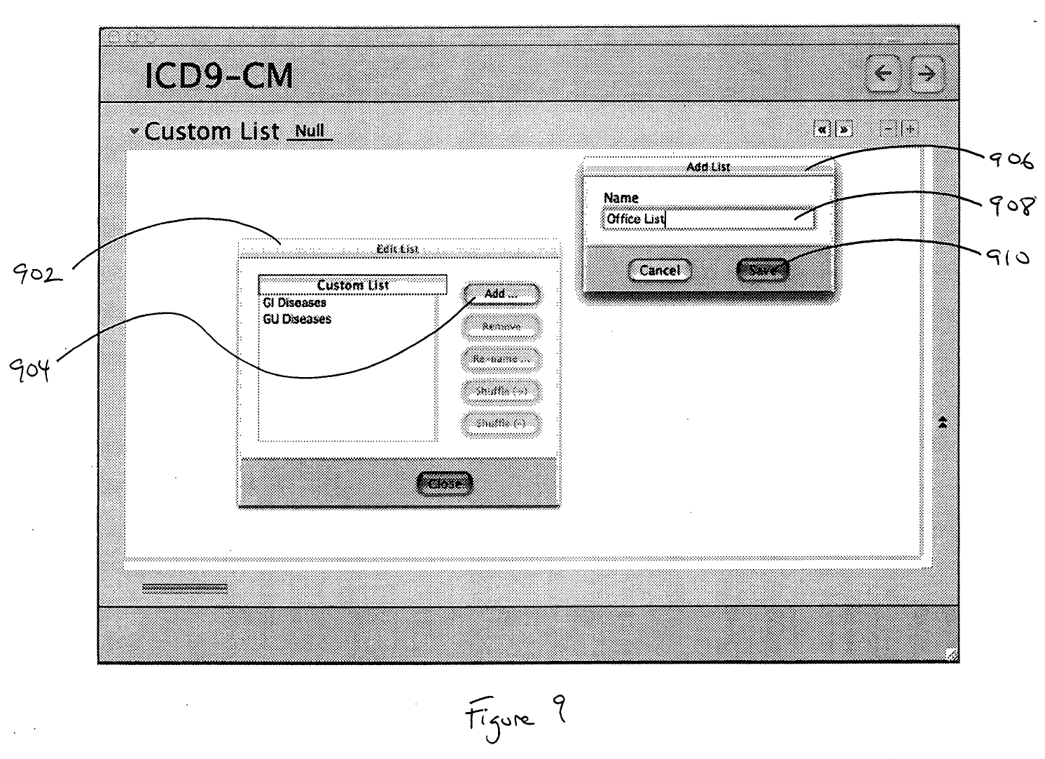

FIG. 9 illustrates an exemplary dialogue box 902 that results from the selection 810 noted on FIG. 8. The dialogue box 902 lists two previously generated custom lists, one of which is entitled GI diseases, and the second of which is entitled GU Diseases. In this exemplary instance, a new custom list is desired, and therefore the add button 904 is depressed and, in response, a new dialogue box is opened in the form of the add list dialogue box 906. The user enters a name 908, and then depresses the save button 910. Thus a new list named office list is generated in this exemplary embodiment.

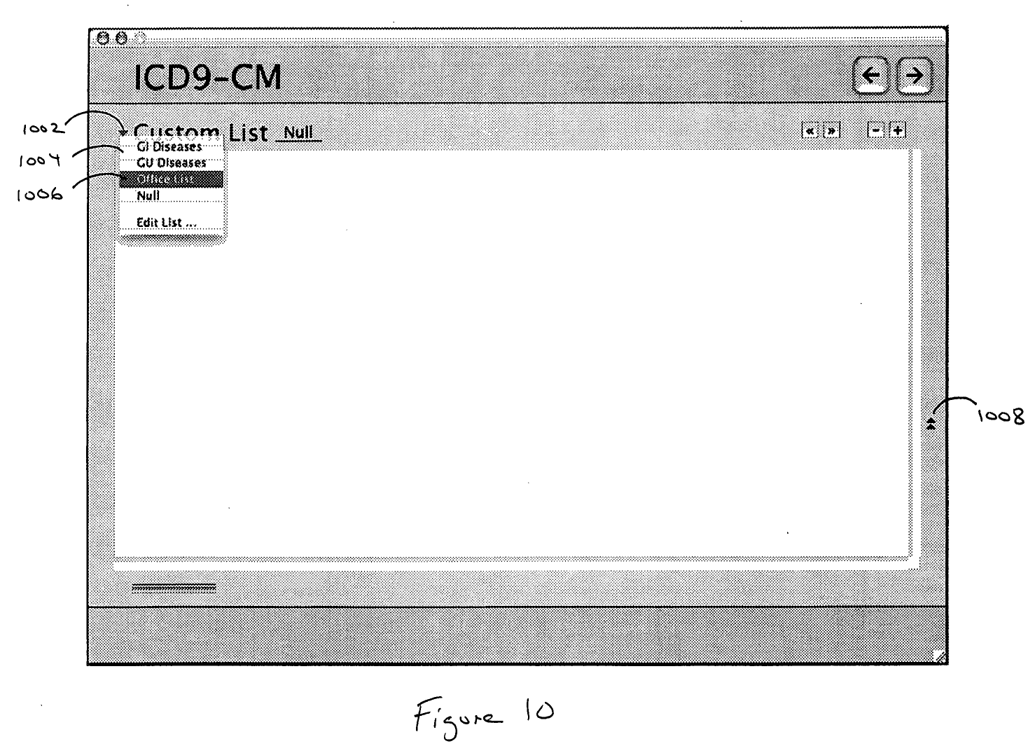

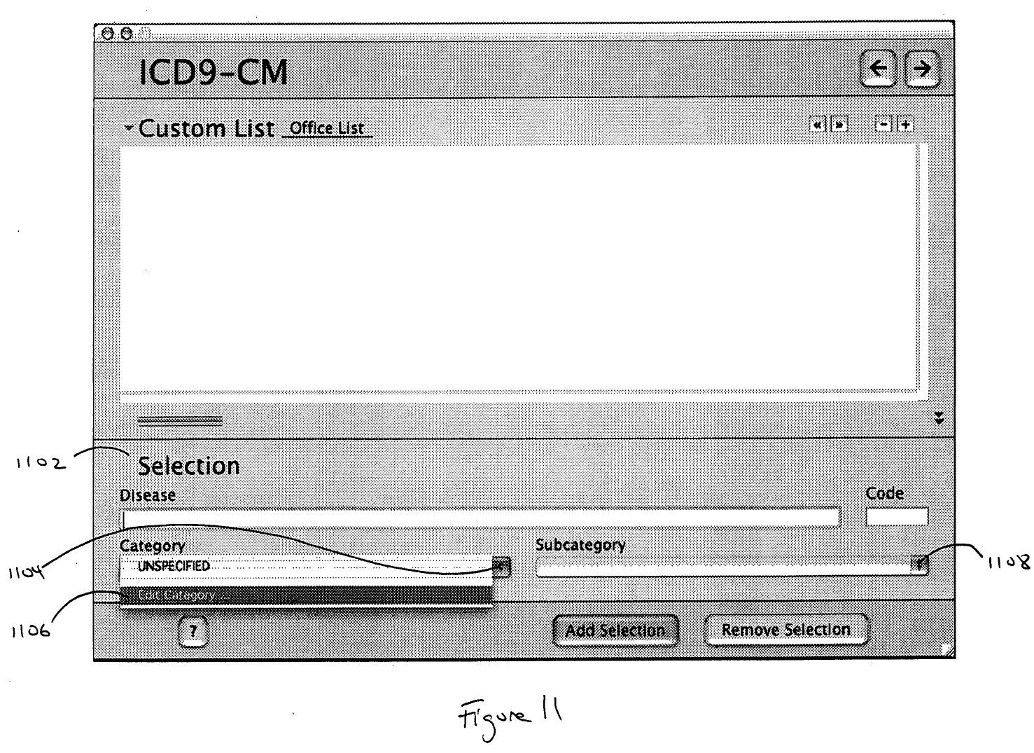

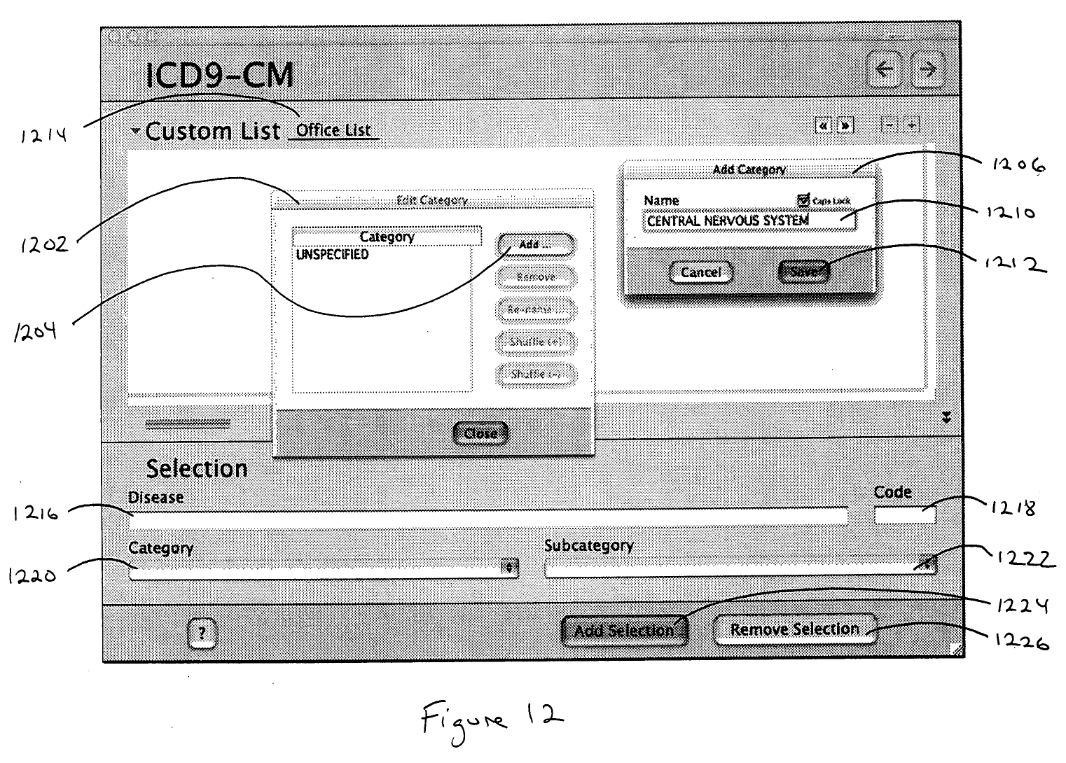

As shown in FIG. 10, the new list may be accessed after creation by pressing over the red triangle 1002 to call forward the hidden menu 1004 and subsequently by selecting the new list entitled office list 1006. The custom list entitled office list is then displayed. However the newly generated list is an empty container. Content may be added to the list by first depressing a button 1008. Upon depressing button 1008, the listbox itself, as shown in FIG. 11, is reduced in dimension so as to allow for the appearance of a “selection” 1102, representing an item to be added to or removed from the custom list. In order to populate the custom list, the user may first determine a category for the selection. To do so, the user presses the category menu 1104 and selects the item edit category 1106. By choosing edit category 1106 the user calls forward the edit category dialogue box 1202 of FIG. 12. Upon pressing the add button 1204, an add category dialogue box 1206 appears. The user may then enter a name for the category, and in this non-limiting example, central nervous system has been entered 1210. The save button 1212 may then be depressed to establish the category, central nervous system, for the particular custom list named office list 1214.

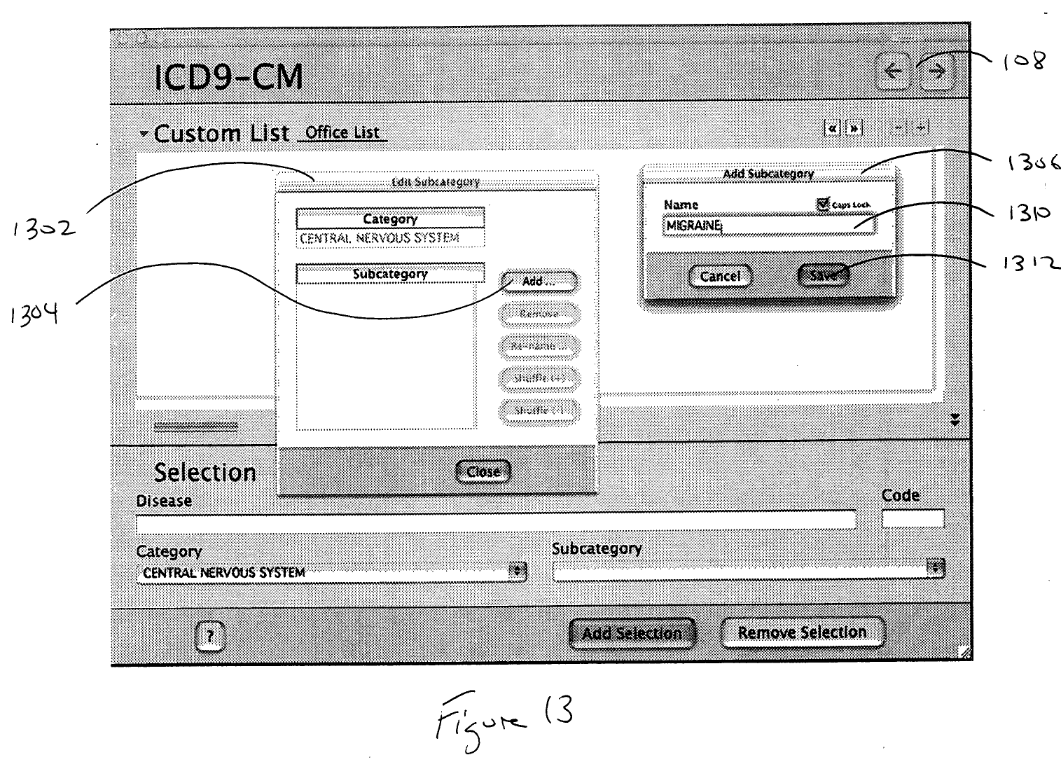

In a similar fashion, a subcategory may be generated for the category central nervous system. Initially, button 1108 may be depressed and edit subcategory may be chosen from the drop down menu. In response, as shown in FIG. 13, the edit subcategory dialogue box 1302 appears. No subcategories are present in the newly generated category of central nervous system, and the user may generate a new subcategory by depressing the add button 1304. The add subcategory dialogue box 1306 may then appear. In this example, the user has typed in the subcategory of migraine 1310. Depressing the save button 1312 generates the subcategory migraine within the category central nervous system.

The category central nervous system and the subcategory migraine establish a container for disease entries. The custom list may use the Tabular List for generating the disease names and codes that will populate the newly generated custom list.

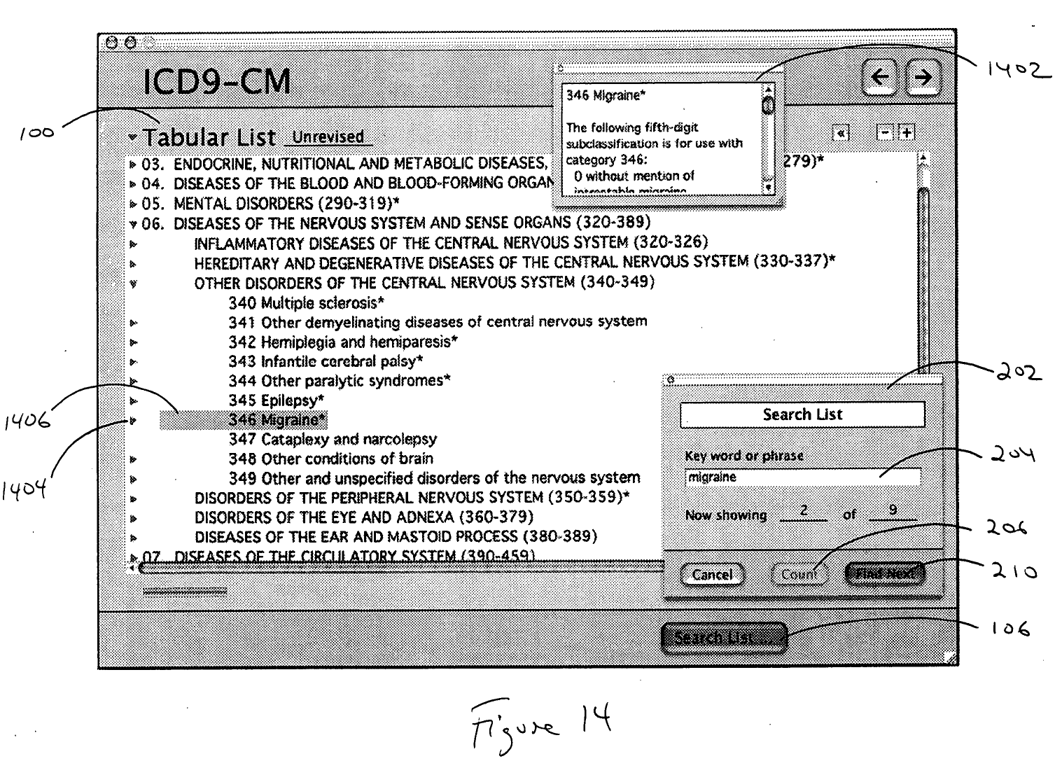

In an exemplary embodiment, using arrows 108 of FIG. 13, the listbox may be changed from that of Custom List to that of Tabular List. As shown in FIG. 14, the Tabular List may be accessed to search for diseases and respective codes, such that the custom list may be populated. Once the Tabular List 100 is displayed, the search list button 106 may be depressed to bring up the search list dialogue box 202. In this non-limiting example, the caregiver/user might identify the disease migraine 204 as a key word for a search of the Tabular List. The count button 206 is depressed and the number of occurrences of the key term migraine is found to be “9”. The caregiver/user may examine the first occurrence of the term and elect not to utilize that instance. The caregiver/user may then depress the find next button 210 to find the next occurrence of the word migraine in the Tabular List. The next occurrence is revealed in the listbox and is selected 1406. Because the selected item is followed by an asterisk, additional information becomes available as a pop up window 1402. The caregiver may inspect the contents of the selected item 1406 by clicking on the appropriate disclosure element 1404.

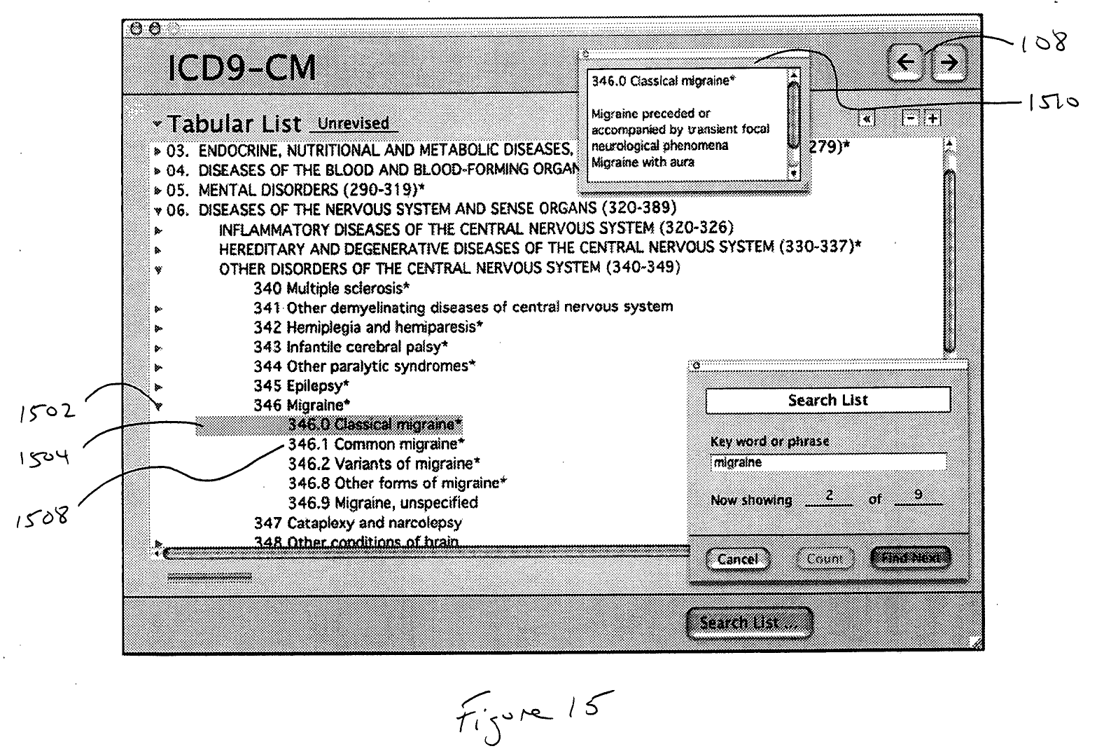

FIG. 15 illustrates the items contained within and located beneath the selected item. Note that the once closed container is now opened, and accordingly the disclosure element 1502 has been rotated. The first entry under the disease migraine has been highlighted by the user 1504, which caused a pop-up window to be revealed 1510. After highlighting this specific disease of interest, the user may change the window to that of the custom list by depressing buttons 108 until the custom list box appears.

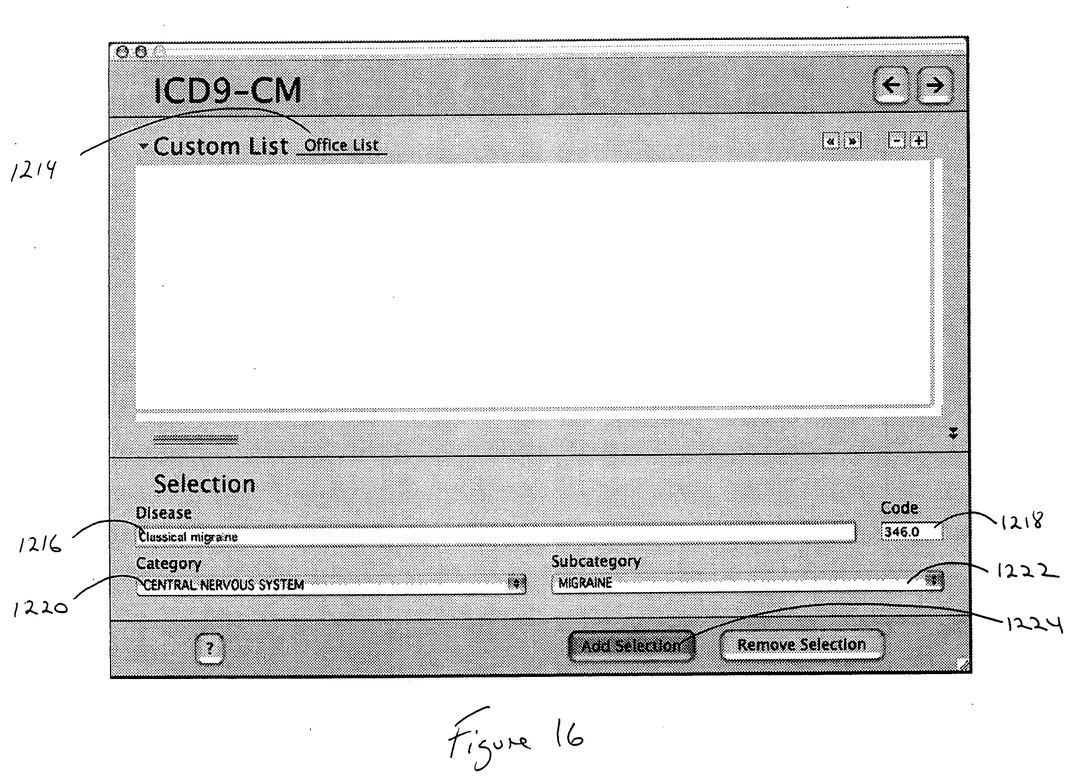

FIG. 16 illustrates a screen shot of the custom list named office list 1214. Upon return to the custom list being generated by the user, the specific disease and code highlighted in the Tabular List may be made available as a selection to be added to the custom list. Changes may be manually made to the imported disease name or to the code. The caregiver/user then may verify that the information of the present “selection” is correct by viewing the category 1220, the subcategory 1222 and the disease 1216 plus code 1218. The selection may then be added to the custom list by depressing the add selection button 1224, for example. After the add selection button is pressed, another disease and code may be defined either by directly typing them or by importation. For an importation, the caregiver/user may return to the Tabular Listing using push buttons 108 until the Tabular List appears.

Returning now to FIG. 15, the next available disease shown is the common migraine 1508. Note that, upon returning to the Tabular List, the search position is preferably retained. Upon highlighting the disease common migraine, the disease may be placed in a buffer such that it is available as data when the user returns to the custom list, such as by using the arrow selector push buttons 108. Returning to FIG. 16, after highlighting the next available disease, the disease is found to have been placed in the disease line 1216 and the corresponding code to have been placed into the code line 1218. The user then may press the add selection button. By repeating these steps of defining a selection and of adding the selection to the custom list, the user is able to populate the custom list to any size the user may desire. A custom list may be populated with any pre-existing disease listing of the Tabular List or it may be populated with a disease listing from another source.

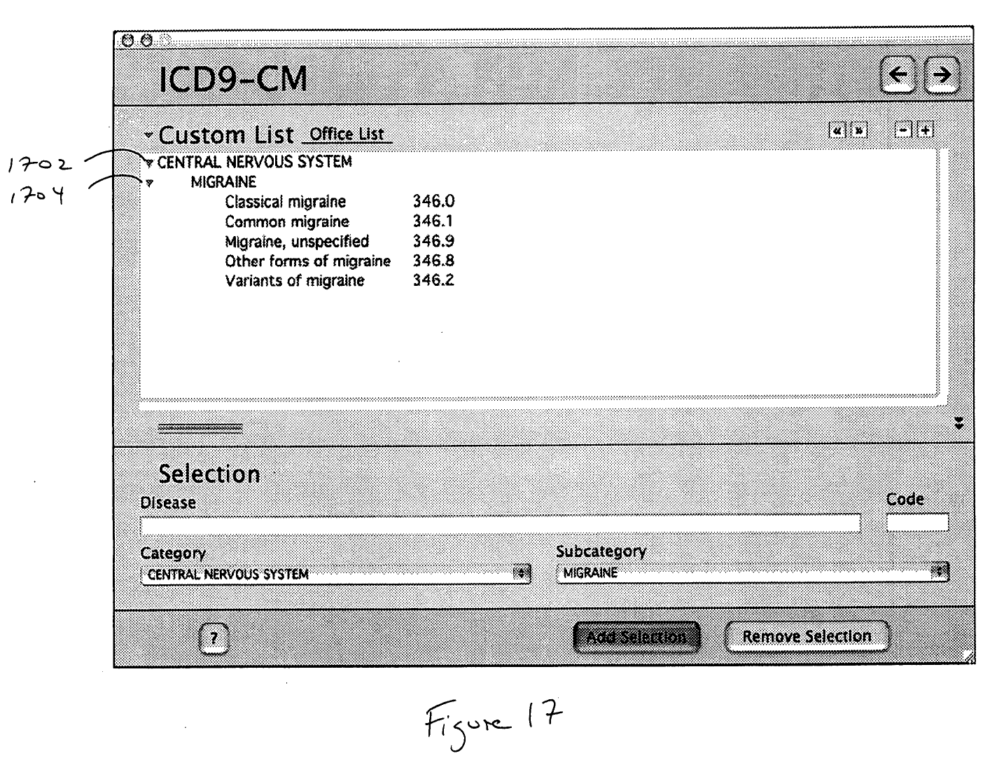

FIG. 17 illustrates a screen shot of the custom list generated hereinabove, entitled office list. A single category, central nervous system, is included in the list. The category may be opened, using, for example, the disclosure element 1702 described hereinabove, to reveal the subcategory migraine. The subcategory migraine may also be opened via, for example, disclosure element 1704, to reveal, for example, five types of migraines with corresponding ICD9-CM codes. In a like manner, larger lists may be generated.

A custom list is portable. For example, the custom list may be exported to a standard application such as Microsoft EXCEL® or Microsoft Word® and manipulated or printed for office use. The print operation will be apparent to those skilled in the art, such as wherein the custom list is displayed on the computer screen and, using the dropdown menus, print options and the print function may be selected.

Custom lists are useful for medical practices where only relatively few diseases and codes are required for most patient encounters. For example, wherein the practitioner is an ear specialist, only diseases of the ear and collateral areas may appear on billing sheets. Therefore, only a smaller list is needed, and the Tabular List need not be accessed and searched. The smaller custom list may thus serve the majority of a specialist's needs.

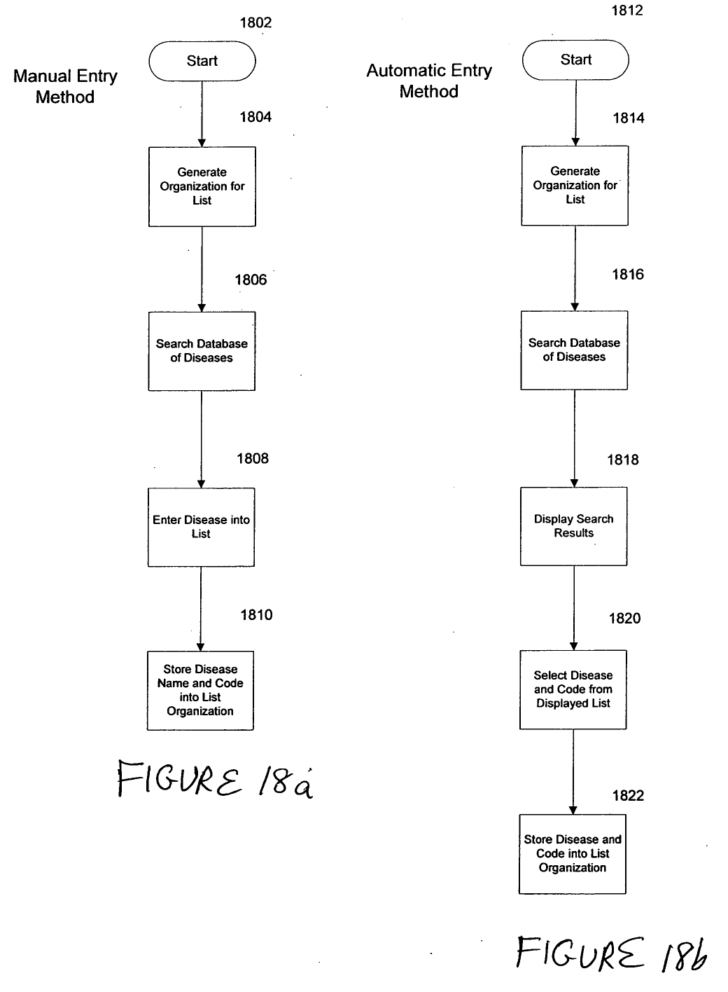

FIGS. 18a and 18b are flow diagrams illustrating methods of generating of a custom list in the present invention. The methods of FIGS. 18a and 18b may be used with, for example, the system set forth hereinabove. A manual method of entry begins at step 1802. An organizational list may be generated in step 1804, which organizational list may include, for example, four tiers of structure, such as list name, category, subcategory, and disease name. A response to a search request from a user to search the standard ICD9-CM database for a disease is generated in step 1806. The selected disease may be manually entered into the list at step 1808. The entry may be stored into the organization of the list at step 1810. If additional entries are needed or desired, steps 1806 through 1810 may be re-executed.

An automatic entry method is depicted in FIG. 18b, and begins at step 1812. Step 1814 generates an organization for the list, which organization may include a list name, category, subcategory, and disease name. A search of the database may be made at step 1816 to locate a disease within the database to be added to the custom list. The results of the search step 1816 are displayed at step 1818, and the selected disease and code may be automatically transferred to the custom list at step 1820. The disease and code may be stored into the custom list at step 1822, and into the organization generated at step 1814. If additional disease entries are needed or desired, steps 1816 through 1822 may be re-executed.

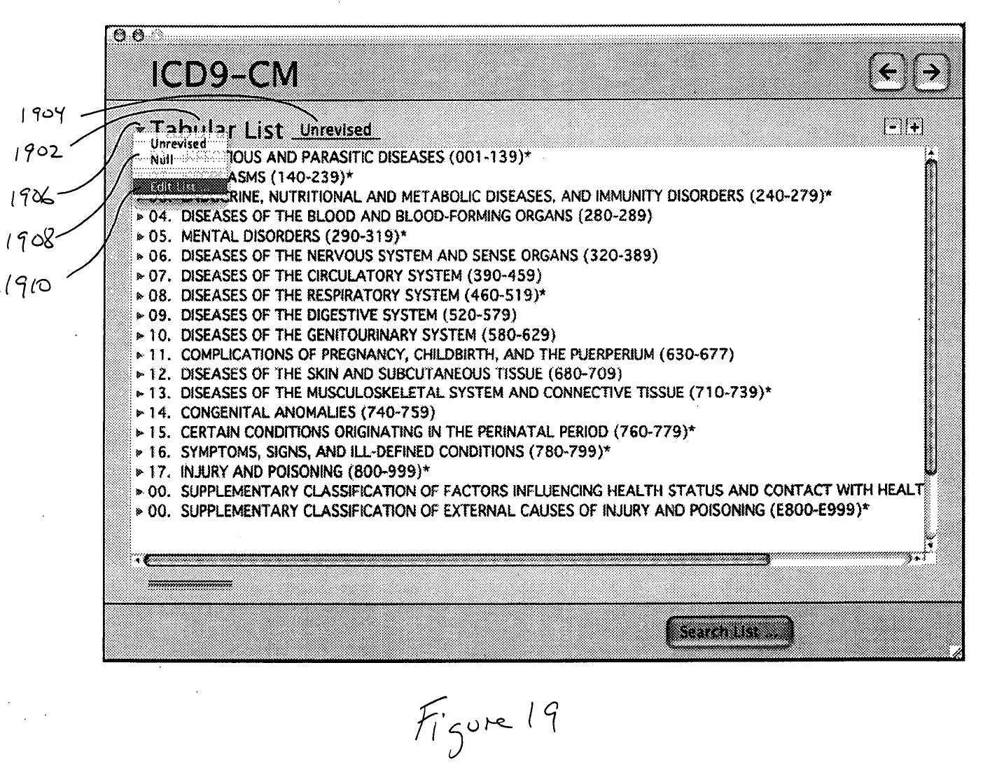

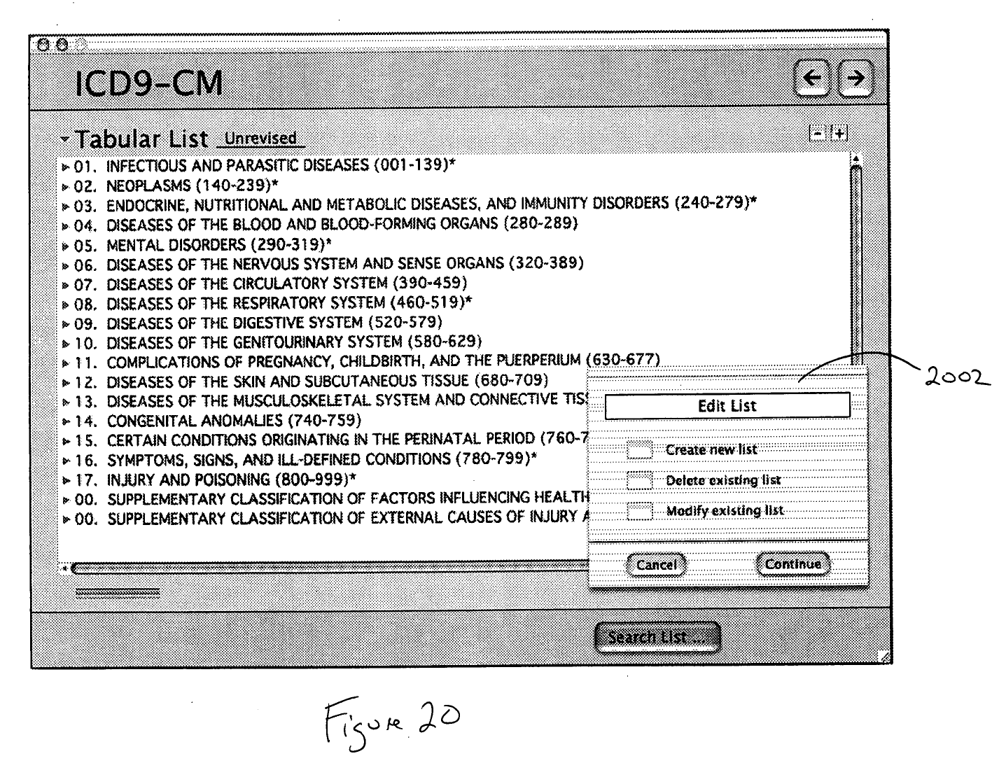

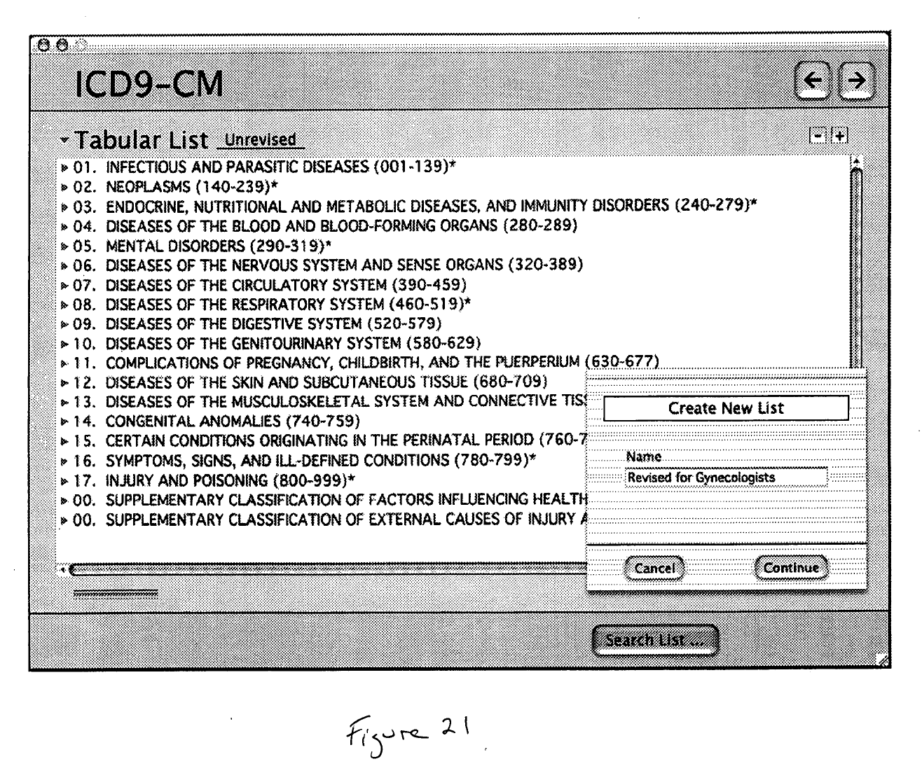

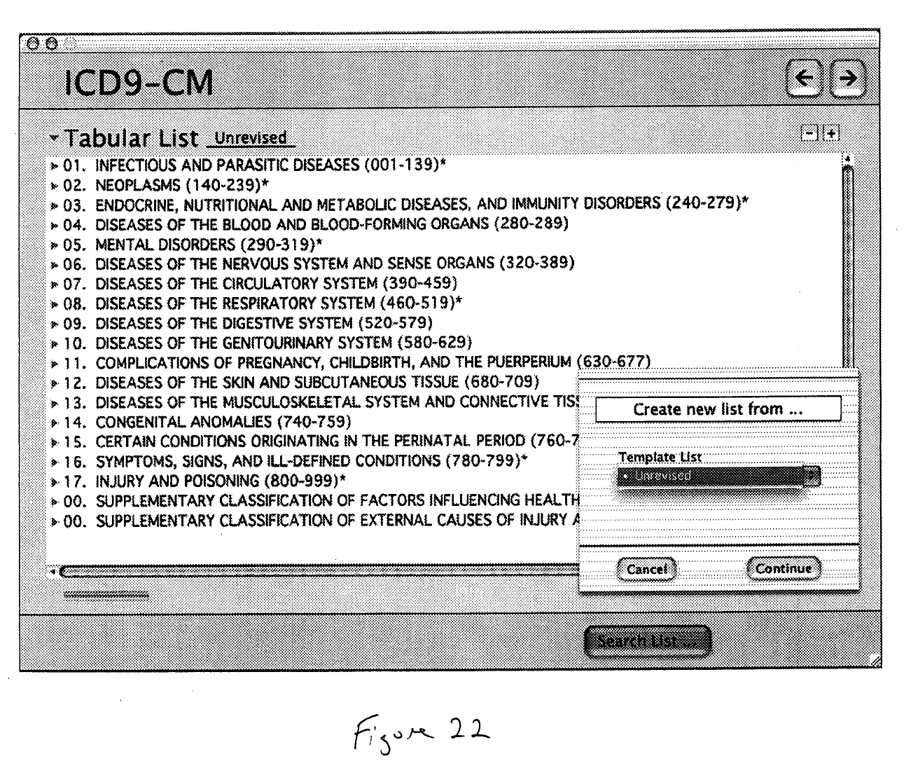

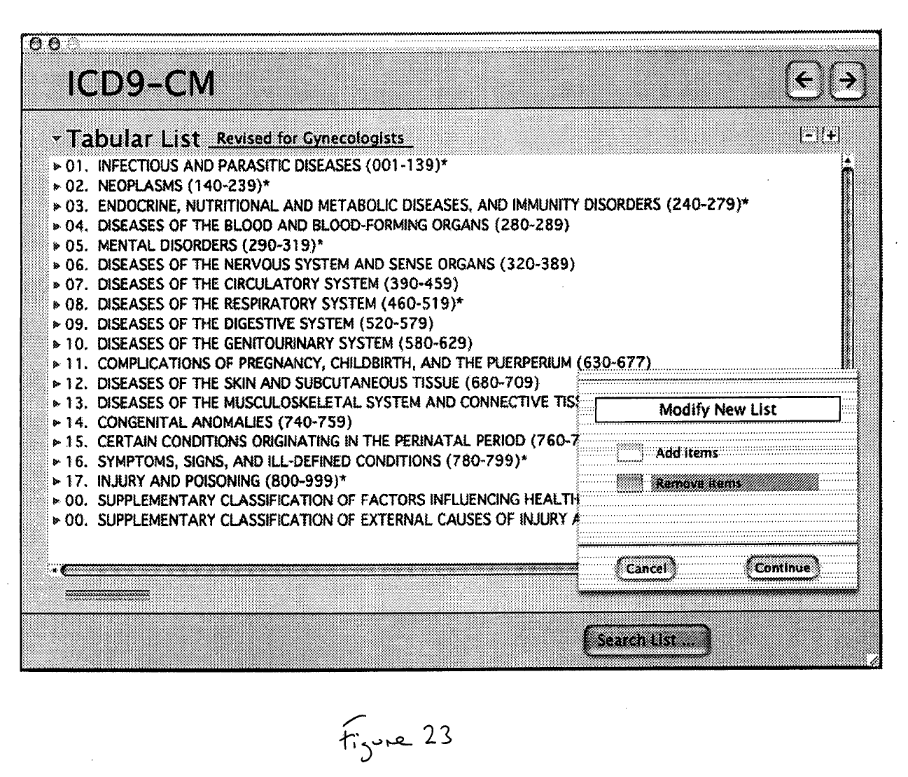

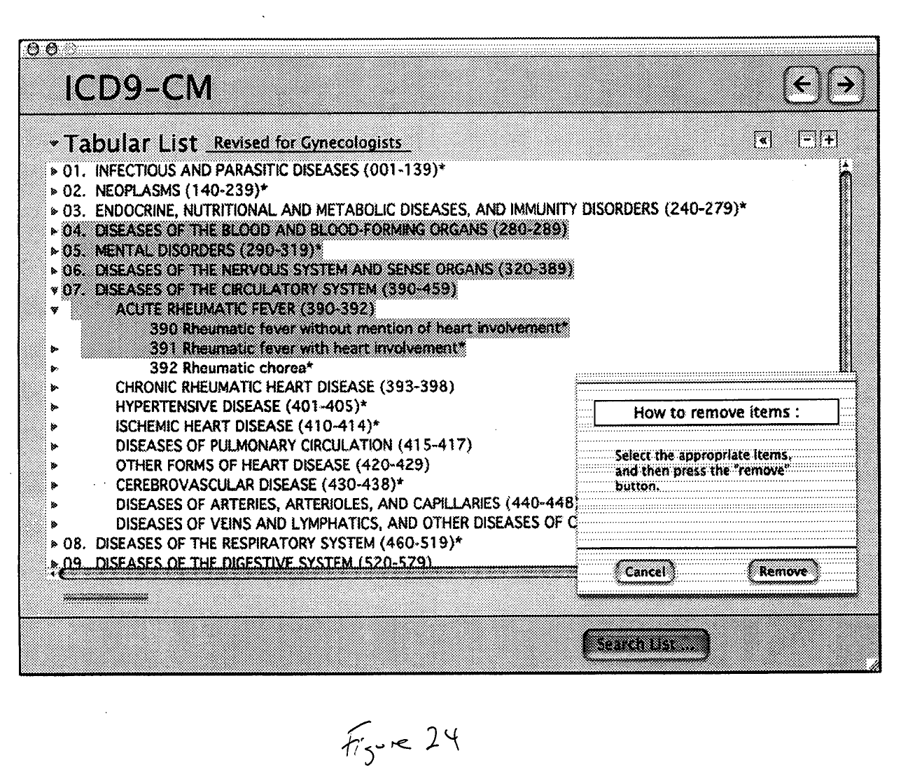

The Tabular List provided by the invention contains the “full data set” for the Tabular List published by the US Government. In one embodiment, which may be referred to as the Enhanced Edition, the invention may allow the capability for this original Tabular List to be copied and revised by the user. Whereas the original Tabular List retains the full data set for the Tabular List, the copied and revised Tabular List may contain only a subset of the full data set. The copied Tabular List may be revised by the user in the manner described here. As shown in FIG. 19, the general title Tabular List 1902 is accompanied by a particular title unrevised 1904. The particular title indicates that the Tabular List within the listbox is the unrevised or original Tabular List comprised of the full data set from the Tabular List of ICD9-CM. Beside the general title is located a large triangle pointing downward 1906. When the user “points” and “clicks” over the triangle, a menu 1908 appears. The menu may allow the user to specify whether the “unrevised” Tabular List or a revised Tabular List appears in the listbox. Additionally, the menu may allow the user by choosing “Edit List . . . ” 1910 to create and/or modify a revised Tabular List. As shown in FIG. 20, upon choosing “Edit List . . . ” , the user is presented a wizard 2002 that serves as a guide for creating or modifying a revised Tabular List. Initially, within the wizard, the user may press the button marked create new list 2004, at which point the wizard will ask the user first to name the new list (FIG. 21) and then to select a template for the new list (FIG. 22)—that template may be the unrevised Tabular List or may be an existing revised Tabular List. Next, the wizard will ask the user to indicate whether the user wants to add or remove items from the template to create the new list (FIG. 23). If the template is the original Tabular List, then the wizard will only allow that items be removed, because a revised Tabular List must be an exact subset of the original Tabular List. If the user chooses to remove items from the template, then the user need only select the items and then press the remove button (FIG. 24). If the user chooses to add items to the list, then the user must first indicate a donor Tabular List from which the items will be added and then need only select the items from that donor list to be added to the new list and press the add button. Whereas a custom list might be modest in scale and suited to an individual practitioner (e.g. ear specialist), a revised Tabular List may be considerable in scale and suited to a group of practitioners (e.g. ear specialists belonging to a national association).

The present invention preferably allows for searches of the database by a plurality of methods, such as by code number, and within a plurality of hierarchies, such as by diagnosis codes within codes. For example, if the code for a particular disease is believed known, but the user wishes to confirm that the code is correct, the user may type the code in a search window, and the diagnosis associated with the code entered may be returned. If the code entered has certain of the digits missing, as much information about the category or subcategory estimated by the software may be returned. Additionally, a wildcard term, such as “?”, may be available for a portion of an entry into the search window in the event that all desired search criteria are not known by the user.

The software discussed herein may be resident on any personal computer, server, or mainframe. Additionally, the code search software may run on a Programmable Digital Assistant (PDA) such as a Palm Pilot® or the like. The code search software may utilize a Windows-based graphical user interface, as discussed herein. The code search may be in any programming language, such as C++, REALbasic, Java, and/or XCMD, for example. The search may make use, for example, of an object-relational database engine, such as the Valentia database kernel from Paradigma Software of Beaverton, Oreg.

It will be apparent to those skilled in the art that various modifications and variations may be made in the apparatus and process of the present invention without departing from the spirit or scope of the invention. Thus, it is intended that the present invention cover the modification and variation of this invention provided those modifications and variations come within the scope of the appended claims and equivalents thereof.

What is claimed is:

1. A method for providing a computerized, customized list of user selectable diagnoses for facilitating medical coding by medical professionals, said method comprising:
generating a hierarchical organization associated with ICD9-CM code for the customized list;
searching data indicative of the ICD9-CM code for at least one item of the ICD9-CM code in accordance with at least one received request to add at least one diagnosis to the customized list;
storing at least one disease name and at least one code each corresponding to the at least one item of the ICD9-CM code within said hierarchical organization into said custom list; and,
displaying each stored disease name and corresponding code in an expandable and collapsible tree structure indicative of said hierarchical organization and in a user selectable manner.

2. The method of claim 1, further comprising repeating said entering and storing to add at least one additional disease name and corresponding code into said custom list.

3. The method of claim 1, wherein said hierarchical organization comprises a list name, a category, and a subcategory.

4. The method of claim 1, wherein said storing comprises receiving manually entered data.

5. The method of claim 1, further comprising loading said data indicative of said ICD9-CM code into at least one volatile memory device.

6. The method of claim 5, wherein said storing comprises automatically transferring data from said volatile memory device into said custom list.

7. A computer program product being embodied on a computer-readable medium which, when executed by a computer, implements a method for providing a computerized, customized list of user selectable diagnoses for facilitating medical coding by medical professionals, said computer program product comprising:
code for generating a hierarchical organization associated with ICD9-CM code for the customized list;
code for searching data indicative of the ICD9-CM code for at least one item of the ICD9-CM code in accordance with at least one received request to add at least one diagnosis to the customized list;
code for storing at least one disease name and at least one code each corresponding to the at least one item of the ICD9-CM code within said hierarchical organization into said custom list; and,
code for displaying each stored disease name and corresponding code in an expandable and collapsible tree structure indicative of said hierarchical organization and in a user selectable manner.

8. The computer program product of claim 7, further comprising code for repeating said entering and storing to add at least one additional disease name and corresponding code into said custom list.

9. The computer program product of claim 7, wherein said hierarchical organization comprises a list name, a category, and a subcategory.

10. The computer program product of claim 7, wherein said storing comprises receiving manually entered data.

11. The computer program product of claim 7, further comprising code for loading said data indicative of said ICD9-CM code into at least one volatile memory device.

12. The computer program product of claim 11, wherein said storing comprises automatically transferring data from said volatile memory device into said custom list.

13. A method for generating a customized list of diseases from a standard disease database, the method comprising:
generating a hierarchical organization for the customized list, wherein said hierarchical organization is in accordance with a primary hierarchical organization of said standard disease database;
searching the standard disease database for at least one item in accordance with at least one received customization instruction, wherein the at least one item is a subset of the standard disease database;
entering at least one disease name, and at least one code corresponding thereto from the standard disease database into said hierarchical organization, said at least one disease name and at least one code each correspondent to the at least one item; and
storing said at least one disease name and said at least one corresponding code within said hierarchical organization into said custom list.

14. The method of claim 13, further comprising repeating said entering and storing to add at least one additional disease name and corresponding code into said custom list.

15. The method of claim 13, wherein said hierarchical organization comprises a list name, a category, and a subcategory.

16. The method of claim 13, wherein said standard disease database comprises an international classification of diseases listing.

17. The method of claim 13, wherein said standard database is indicative of an ICD9-CM code.

18. The method of claim 17, wherein said searching comprises searching the ICD9-CM code.

19. The method of claim 13, wherein said step of entering said disease name and corresponding code comprises manually typing said disease name and corresponding code.

20. A method for generating a custom list of diseases from a standard disease database using computer software, the method comprising:
generating a hierarchical organization to contain said custom list;
searching said standard disease database for diseases and corresponding codes using said computer software;
displaying results from said searching step;
receiving user input selecting from said displayed results a disease and corresponding code to add to said custom list; and
storing data indicative of said disease and corresponding code into said hierarchical organization within said custom list;
wherein, said storing at least copies said selected disease and corresponding code from said standard disease database to said custom list, and said custom list comprises said hierarchical organization populated with said selected diseases and corresponding codes.

21. The method of claim 20, further comprising repeating said searching, displaying, selecting and storing to add additional disease names and corresponding codes into said custom list.

22. The method of claim 20, wherein said hierarchical organization comprises a list name, a category, and a subcategory.

23. The method of claim 20, wherein said standard disease database comprises an international classification of diseases listing.

24. The method of claim 20, wherein said classification corresponds to the ICD9-CM code.

25. The method of claim 24, further comprising loading said ICD9-CM code into at least one volatile memory device.

26. The method of claim 20, wherein said selecting and storing, in combination, automatically transfers data of the selected disease and corresponding code to said custom list.

27. A system for searching a standard disease database comprising a hierarchy of disease listings, wherein the hierarchy includes an upper level and at least two lower levels, said system comprising:
at least one computing device suitable for executing a plurality of instructions in the form of code; and, a code searcher resident on said computer;
wherein, said code searcher comprises code for, after selection of the at least one upper level, receiving a search request within at least one of the at least two lower levels, and searching at least one of the at least two lower levels of the standard disease database in accordance with the search request and the hierarchy; and,
wherein, at least one custom list is derived from said standard disease database dependently upon said code searcher.
displaying each stored disease name and corresponding code in an expandable and collapsible tree structure indicative of said hierarchical organization and in a user selectable manner.

28. The system of claim 27, wherein said computing device is one selected from the group consisting of a personal computer, a server, a mainframe, and a programmable digital assistant.

29. The system of claim 27, wherein said code searcher comprises at least one search engine.

30. The system of claim 29, wherein said search engine utilizes a standard database kernel.

31. The system of claim 27, wherein said custom list is organized in accordance with the hierarchy.

32. The system of claim 27, wherein said custom list is expandable by an electronic transfer within said computer.

33. The system of claim 27, wherein said computing instructions enable a user to edit said at least one custom list.

34. The system of claim 27, wherein said code searcher comprises code associated with a language selected from the group consisting of C++, REALbasic, JAVA, and XCMD.

35. A computer program product being embodied on a computer-readable medium which, when executed by a computer, implement a method of generating a custom list of diseases from a standard disease database, said product comprising:
code for generating a hierarchical organization to contain said custom list;
code for searching said standard disease database for diseases and corresponding codes;
code for displaying results from said searching step;
code for receiving user input selecting from said displayed results a disease and corresponding code to add to said custom list; and,
code for storing data indicative of said disease and said corresponding code into said hierarchical organization within said custom list;
wherein, said storing identifies said selected disease and corresponding code from said standard disease database as being associated with said custom list and said custom list comprises said hierarchical organization populated with said selected diseases and corresponding codes.

36. The product of claim 35, wherein said product is adapted to repeat said searching, displaying, receiving a selection, and storing steps to add additional disease names and corresponding codes into said custom list.

37. The product of claim 35, wherein said hierarchical organization comprises a list name, a category, and a subcategory.

38. The product of claim 35, wherein said standard disease database comprises an international classification of diseases listing.

39. The product of claim 35, wherein said selecting step and storing step, in combination, automatically transfers data of the selected disease and corresponding code to said custom list.

40. A method for facilitating medical diagnosis coding comprising:
storing data corresponding to the tabular list of the ICD9-CM medical diagnosis coding in a first table in a hierarchical manner;
providing code for receiving user input for navigating through said tabular list to a desired portion of said data corresponding to said tabular list; and,
providing code for displaying said desired portion of said data corresponding to said tabular list with at least one other portion of said data indicative of said tabular list so as to present said desired portion of said data in an expandable and collapsible tree structure indicative of said hierarchy and in a user selectable manner.

41. The method of claim 40, wherein each portion of said data corresponding to said tabular list is displayed in an expandable and collapsible tree structure with regard to at least one other related portion of said data corresponding to said tabular list dependently upon said hierarchy.

42. The method of claim 40, further comprising storing data corresponding to an Alphabetic Index of the ICD9-CM medical diagnosis coding in a second table so as to be cross-referenced with said data corresponding to said Tabular List.

43. The method of claim 40, wherein said other portion comprises primary data well suited for being displayed in a text line.

44. The method of claim 43, wherein said other portion comprises primary data well suited for being displayed in a text line.

45. The method of claim 44, further comprising storing secondary data corresponding to said desired portion of said primary data in said table.

46. The method of claim 45, further comprising providing code for presenting said secondary data in a pop-up window responsively to user selection of said presented desired portion of said primary data.

47. The method of claim 40, further comprising providing code for searching said data corresponding to said Tabular List for at least one user entered term.

48. The method of claim 47, further comprising providing code for searching said data corresponding to said Alphabetic Index for the at least one user entered term.

49. The method of claim 40, further comprising providing code for exporting at least a portion of said stored data in an electronic form.

50. The method of claim 49, further comprising code for gathering data indicative of said displayed portion of said stored data.

51. A computer program product being embodied on a computer readable medium and for facilitating medical diagnosis coding, said computer program product comprising:
data corresponding to the tabular list of ICD9-CM being stored in at least a first table so as to preserve a hierarchy associated with the ICD9-CM;
code for receiving user input for navigating through said tabular list to a desired portion of said data corresponding to said tabular list; and,
code for displaying said desired portion of said data corresponding to said tabular list with at least one other portion of said data indicative of said tabular list so as to present said desired portion of said data in an expandable and collapsible tree structure indicative of said hierarchy and in a user selectable manner.

52. The product of claim 51, wherein each portion of said data corresponding to said tabular list is displayed in an expandable and collapsible tree structure with regard to at least one other related portion of said data corresponding to said tabular list dependently upon said hierarchy.

53. The product of claim 51, further comprising code for presenting said tabular list of said ICD9-CM in a collapsible manner to facilitate said navigating.

54. The product of claim 53, wherein said code for presenting said tabular list comprises code for presenting said tabular list in a user customizable manner.

55. The product of claim 53, wherein said customizable manner enables expanding and collapsing views of portions of said tabular list.

56. The product of claim 53, further comprising code for searching said tabular list.

57. The product of claim 53, further comprising code for cross-referencing said tabular list with other data.

58. The product of claim 57, wherein said other data comprises the alphabetic index of ICD9-CM.

59. The product of claim 51, further comprising code for defining a subset of said tabular list.

60. The product of claim 59, further comprising code for storing in a volatile memory data indicative of said subset.

61. The product of claim 59, further comprising code for adding entries to said subset.

62. A computer program product being embodied on a computer readable medium and for facilitating medical diagnosis coding, said computer program product comprising:
data corresponding to the tabular list of a medical diagnosis coding being stored in at least a first table so as to preserve a hierarchy associated with the medical diagnosis coding;
code for receiving user input for navigating through said tabular list to a desired portion of said data corresponding to said tabular list; and,
code for displaying said desired portion of said data corresponding to said tabular list with at least one other portion of said data indicative of said tabular list so as to present said desired portion of said data in said hierarchy.

63. A method for providing a computerized, customized list of user selectable diagnoses for facilitating medical coding by medical professionals, said method comprising:
generating a hierarchical organization associated with ICD-10 code for the customized list;
searching data indicative of the ICD-10 code for at least one item of the ICD-10 code in accordance with at least one received request to add at least one diagnosis to the customized list;
storing at least one disease name and at least one code each corresponding to the at least one item of the ICD-10 code within said hierarchical organization into said custom list; and,
displaying each stored disease name and corresponding code in an expandable and collapsible tree structure indicative of said hierarchical organization and in a user selectable manner.
